(19) United States
(12) Patent Application Publication
(10) Pub. No.: US 2019/0148905 A1
(43) Pub. Date: May 16, 2019

(54) GAS LASER DEVICE

(71) Applicant: GIGAPHOTON INC., Tochigi (JP)

(72) Inventors: Hiroshi UMEDA, Oyama-shi (JP); Osamu WAKABAYASHI, Oyama-shi (JP)

(73) Assignee: GIGAPHOTON INC., Tochigi (JP)

(21) Appl. No.: 16/232,637

(22) Filed: Dec. 26, 2018

Related U.S. Application Data
(63) Continuation of application No. PCT/JP2016/073081, filed on Aug. 5, 2016.

(51) Int. Cl. H01S 3/097; H01S 3/0975; H01S 3/104

(52) U.S. Cl. CPC H01S 3/09702; H01S 3/104; H01S 3/0975; H01S 3/09705

(57) ABSTRACT

A discharge excitation gas laser device includes: first and second discharge electrodes disposed to face each other; a plurality of peaking capacitors connected to the first discharge electrode; a charger; a plurality of pulse power modules, each one of the pulse power modules including a charging capacitor to which a charged voltage is applied from the charger, a pulse compression circuit that pulse-compresses and outputs electrical energy stored in the charging capacitor as an output pulse to a corresponding peaking capacitor, and a switch disposed between the charging capacitor and the pulse compression circuit; a plurality of output pulse sensors, each one of the output pulse sensors detecting an output pulse output by a corresponding pulse power module; and a control unit configured to control, based on a detection result of each of the output pulse sensor, a tinting of a switch signal to be input to a corresponding switch.

### CROSS-REFERENCE TO RELATED APPLICATIONS

The present application is a continuation application of International Application No. PCT/JP2016/073081 filed on Aug. 5, 2016. The content of the application is incorporated herein by reference in its entirety.

### BACKGROUND

### 1. Technical Field

The present disclosure relates to a discharge excitation gas laser device.

### 2. Related Art

Along with the miniaturization and high integration of a semiconductor integrated circuit, improvement of resolution is demanded in a semiconductor exposure device. Hereinafter, the semiconductor exposure device is simply referred to as an “exposure device.” Accordingly, shortening of the wavelength of light emitted from a light source for exposure has been sought. As the light source for exposure, a discharge excitation gas laser device is in use in place of a conventional mercury lamp. As a laser device for exposure, a KrF excimer laser device that emits ultraviolet rays of a wavelength of 248 nm and an ArF excimer laser device that emits ultraviolet rays of a wavelength of 193.4 nm are currently employed.

As a current exposure technology, liquid immersion exposure has been used in practice, in which a gap between a projection lens on an exposure device side and a wafer is filled with a liquid to change the refractive index of the gap, thereby shortening the apparent wavelength of the light source for exposure. In the liquid immersion exposure using the ArF excimer laser device as the light source for exposure, ultraviolet rays having a wavelength of 134 nm in water is applied to the wafer. This technology is called ArF liquid immersion exposure. The ArF liquid immersion exposure is also referred to as ArF liquid immersion lithography.

The spectrum line width in natural oscillations of the KrF and ArF excimer laser devices is so wide, about 350 to 400 pm, that a color aberration occurs in the laser light (ultraviolet rays) as projected in a reduced size on the wafer through the projection lens on the exposure device side, and the resolution is degraded. Therefore, it is necessary to narrow the spectrum line width of the laser light emitted from the gas laser device to the extent that the color aberration can be ignored. Accordingly, a line narrowing module having a line narrowing element is provided in a laser resonator of the gas laser device. This line narrowing module is used to achieve narrowing of the spectrum line width. The line narrowing element may be an etalon, a grating, and the like. The laser device with a spectrum line width narrowed in this way is called a narrowband laser device.

### CITATION LIST

### Patent Literature

Patent Literature 1: Japanese Patent Application Laid-Open No. 06-283787

Patent Literature 2: International Publication No. WO 2014/156818

Patent Literature 3: Published Japanese Translations of PCT International Publication for Patent Applications No. 2005-512333

Patent Literature 4: Japanese Patent Application Laid-Open No. 2009-194063

Patent Literature 5: Japanese Patent Application Laid-Open No. 11-177168

Patent Literature 6: International Publication No. WO 2015/190012

### SUMMARY

A discharge excitation gas laser device according to one aspect of the present disclosure may include (A) first and second discharge electrodes, (B) a plurality of peaking capacitors, (C) a charger, (D) a plurality of pulse power modules, (E) a plurality of output pulse sensors, and (F) a control unit.

(A) The first and second discharge electrodes may be disposed to face each other.

(B) The peaking capacitors may be connected to the first discharge electrode.

(D) Each one of the pulse power modules may include (D1) a charging capacitor, (D2) a pulse compression circuit, and (D3) a switch.

(D1) A charged voltage may be applied to the charging capacitor from the charger.

(D2) The pulse compression circuit may pulse-compress electrical energy stored in the charging capacitor, and output the pulse-compressed electrical energy as an output pulse to a corresponding peaking capacitor of the peaking capacitors.

(D3) The switch may be disposed between the charging capacitor and the pulse compression circuit.

(E) Each one of the output pulse sensors may detect an output pulse output by a corresponding one of the pulse power modules.

(F) The control unit may be configured to control, based on a detection result of each of the output pulse sensors, a timing of a switch signal to be input to a corresponding switch.

### BRIEF DESCRIPTION OF THE DRAWINGS

Some embodiments of the present disclosure will be described as an example below with reference to the accompanying drawings.

FIG. 1 is a diagram schematically illustrating a configuration of a laser device according to a comparative example;

FIG. 2 is a cross-sectional view of a gas laser device as viewed in a Z direction;

FIG. 3 is a circuit diagram illustrating configurations of a PPM(1) to a PPM(n);

FIG. 4 is a graph showing a relationship between a charged voltage and a required time from a time of inputting a switch signal to PPM(k) to a time of applying a voltage to a discharge electrode;

FIG. 5 is a block diagram illustrating a configuration of a synchronization control unit;

FIG. 6 is a timing chart illustrating a relationship among an external trigger signal, an internal trigger signal, and a switch signal;

FIG. 7 is a flowchart illustrating a process performed by a laser control unit;

FIG. 8 is a flowchart illustrating a process performed by a trigger correction unit;

FIG. 9 is a timing chart in the gas laser device according to the comparative example;

FIG. 10 is a timing chart for explaining problems in the gas laser device according to the comparative example;

FIG. 11 is a diagram schematically illustrating a configuration of a gas laser device according to a first embodiment;

FIG. 12 is a circuit diagram illustrating configurations of a PPM(1) to a PPM(n);

FIG. 13 is a block diagram illustrating a configuration of a synchronization control unit;

FIG. 14 is a timing chart illustrating a relationship among an external trigger signal, an internal trigger signal, a switch signal and a detection signal;

FIG. 15 is a flowchart illustrating a process performed by a trigger correction unit;

FIG. 16 is a diagram schematically illustrating a configuration of a gas laser device according to a second embodiment;

FIG. 17 is a circuit diagram illustrating configurations of a PPM(1) to a PPM(n);

FIG. 18 is a block diagram illustrating a configuration of a synchronization control unit;

FIG. 19 is a flowchart illustrating a calculation process of time difference data;

FIG. 20 is a flowchart illustrating a calculation process of a delay time;

FIG. 21 is a timing chart in the gas laser device according to the second embodiment;

FIG. 22 is a diagram schematically illustrating a configuration of a gas laser device according to a third embodiment;

FIG. 23 is a block diagram illustrating a configuration of a synchronization control unit;

FIG. 24 is a flowchart illustrating a calculation process of time difference data and a charged voltage;

FIG. 25 is a diagram schematically illustrating a configuration of a gas laser device according to a fourth embodiment;

FIG. 26 is a block diagram illustrating a configuration of a synchronization control unit;

FIG. 27 is a timing chart illustrating a relationship among an external trigger signal, an internal trigger signal, a switch signal and a detection signal;

FIG. 28 is a flowchart illustrating a correction process of a delay time by a delay time correction unit;

FIG. 29 is a diagram illustrating a specific example of an output pulse sensor in a current detection system;

FIG. 30 is a diagram illustrating a specific example of an output pulse sensor for detecting a charging timing based on a waveform of a current flowing through a peaking capacitor;

FIG. 31 is a graph showing an operation of a comparator;

FIG. 32 is a diagram illustrating a specific example of an output pulse sensor in a current detection system;

FIG. 33 is a diagram illustrating a specific example of an output pulse sensor for detecting a charging timing based on a waveform of a voltage applied to the peaking capacitor;

FIG. 34 is a graph showing an operation of a comparator;

FIG. 35 is a diagram illustrating a specific example of an optical sensor included in a discharge sensor;

FIG. 36 is a graph showing an operation of a comparator.

### EMBODIMENTS

<Contents>

### 1. Comparative Example

1.1 Configuration
1.1.1 Overview of gas laser device
1.1.2 Pulse power module
1.1.3 Synchronization control unit

1.2 Operation
1.2.1 Processing in laser control unit
1.2.2 Processing in trigger correction unit
1.2.3 Overall operation of gas laser device

1.3 Problem

### 2. First Embodiment

2.1 Configuration

2.2 Operation
2.2.1 Processing in laser control unit
2.2.2 Processing in trigger correction unit
2.2.3 Overall operation of gas laser device

2.3 Effect

### 3. Second Embodiment

3.1 Configuration

3.2 Operation
3.2.1 Calculation process of time difference data
3.2.2 Calculation process of delay time
3.2.3 Generation process of internal trigger signal
3.2.4 Overall operation of gas laser device

3.3 Effect

### 4. Third Embodiment

4.1 Configuration

4.2 Operation
4.2.1 Calculation process of time difference data and charged voltage
4.2.2 Processing in trigger correction unit
4.2.3 Overall operation of gas laser device

4.3 Effect

### 5. Fourth Embodiment

5.1 Configuration

5.2 Operation
5.2.1 Correction process of delay time of internal trigger signal to external signal
5.2.2 Overall operation of gas laser device

5.3 Effect

### 6. Specific Example of Output Pulse Sensor

6.1 Output pulse sensor in current detection system

6.2 Output pulse sensor in voltage detection system

### 7. Specific Example of Discharge Sensor

### 8. Modification Example of Pulse Power Module

8.1 Configuration

8.2 Effect

Hereinafter, embodiments of the present disclosure will be described in detail with reference to the drawings. The embodiments described below illustrate some examples of the present disclosure, and do not limit the contents of the present disclosure. Further, all of the configurations and the operations described in the embodiments are not always indispensable as configurations and operations of the present disclosure. The same constituent elements are denoted by the same reference signs, and redundant description is omitted.

### 1. Comparative Example

1.1 Configuration

1.1.1 Overview of Gas Laser Device

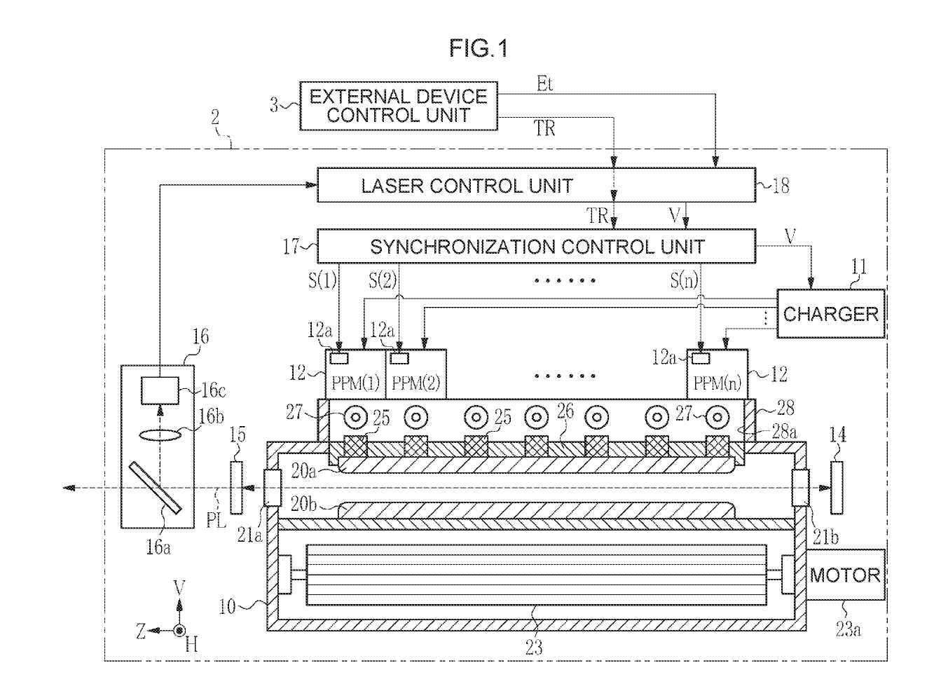

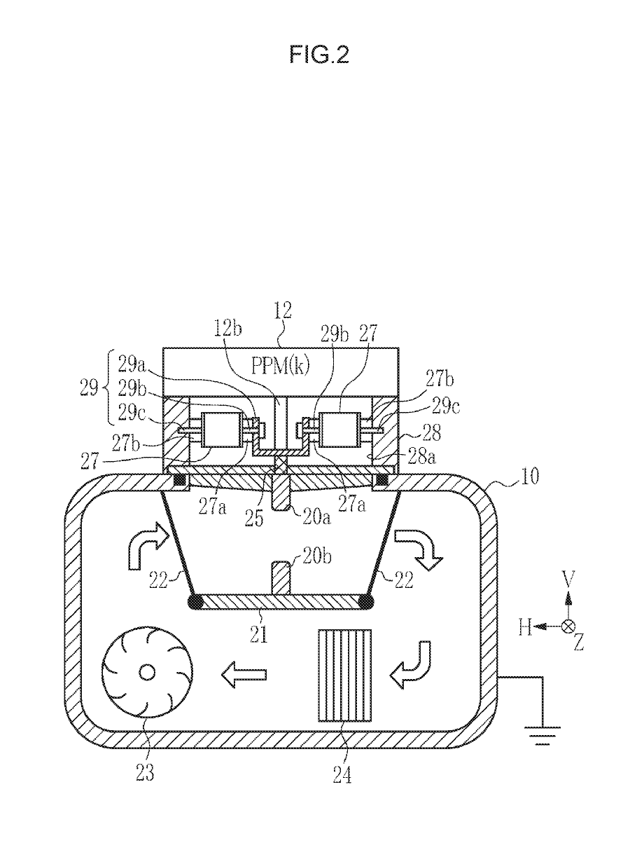

FIG. 1 and FIG. 2 each schematically illustrate a configuration of a gas laser device 2 according to a comparative example. FIG. 1 schematically illustrates the configuration of the gas laser device 2. FIG. 2 is a cross-sectional view of the gas laser device 2 illustrated in FIG. 1 as viewed in a Z direction. The gas laser device 2 is a discharge excitation gas laser device such as an excimer laser device.

In FIG. 1, the Z direction is defined as a traveling direction of pulse laser light PL emitted from the gas laser device 2. A V direction is defined as a direction of electric discharge between first and second discharge electrodes 20a and 20b which are described later. An H direction is defined as a direction which is perpendicular to both of the Z direction and the V direction.

In FIG. 1, the gas laser device 2 includes, a laser chamber 10, a charger 11, and a plurality of pulse power modules (PPMs) 12. The gas laser device 2 further includes a rear mirror 14, an output coupling mirror 15, a pulse energy measurement unit 16, a synchronization control unit 17, and a laser control unit 18.

First and second discharge electrodes 20a and 20b as main electrodes, a ground plate 21, wires 22, a fan 23, and a heat exchanger 24 are provided in the laser chamber 10. The laser chamber 10 may be provided with a preliminary electrode (not illustrated) therein.

Laser gas serving as a laser medium is enclosed in the laser chamber 10. The laser gas contains, for example, rare gas such as argon gas, krypton gas, or xenon gas, buffer gas such as neon gas or helium gas, and halogen gas such as chlorine gas or fluorine gas, etc.

An opening is formed at the laser chamber 10. An electric insulation plate 26 in which a plurality of feedthroughs 25 are embedded is provided to plug the opening. A plurality of peaking capacitors (Cp) 27 and a holder 28 which holds these peaking capacitors 27 are disposed on this electric insulation plate 26. The plurality of PPMs 12 are disposed on this holder 28. In addition, the laser chamber 10 is provided with windows 21a and 21b.

The first and second discharge electrodes 20a and 20b are disposed to face each other in the laser chamber 10 as electrodes for exciting the laser medium by a discharge. The first discharge electrode 20a and the second discharge electrode 20b are disposed such that their discharge surfaces face each other. A space between the discharge surface of the first discharge electrode 20a and the discharge surface of the second discharge electrode 20b is referred to as a “discharge space.” A surface opposite to the discharge surface of the first discharge electrode 20a is supported on the electric insulation plate 26. A surface opposite to the discharge surface of the second discharge electrode 20b is supported on the ground plate 21.

The feedthroughs 25 are connected to the first discharge electrode 20a. As illustrated in FIG. 2, the feedthrough 25 is connected to a pair of peaking capacitors 27 through a connecting part 29, the peaking capacitors 27 being held to the holder 28. The connecting part 29 is a member for connecting the peaking capacitors 27 with the other constituent element.

Walls 28a which form an internal space of the holder 28 are formed of a metal material such as aluminum metal. The peaking capacitors 27, the connecting part 29, and a high voltage terminal 12b of the PPM 12 are disposed in the holder 28. The peaking capacitors 27 each are a capacitor for supplying electrical energy to the first and second discharge electrodes 20a and 20b. The pair of peaking capacitors 27 receive the electrical energy from the corresponding PPM 12 to accumulate the electrical energy therein, and then discharge the accumulated electrical energy to the first and second discharge electrodes 20a and 20b.

The pair of peaking capacitors 27 are disposed in the H direction. A plurality of peaking capacitors 27 may be disposed in the Z direction. One electrode 27a of the peaking capacitor 27 is connected to the high voltage terminal 12b and the feedthrough 25 through the connecting part 29. The other electrode 27b of the peaking capacitor 27 is connected to a wall 28a of the holder 28 through the connecting part 29.

The connecting part 29 includes a connecting plate 29a, and connecting terminals 29b and 29c. The connecting plate 29a is made up of a conductive plate having a U-shaped cross section, and is connected to the high voltage terminal 12b and the feedthrough 25.

The ground plate 21 is connected to the laser chamber 10 through the wires 22. The laser chamber 10 is connected to ground. The ground plate 21 is maintained at a ground potential through the wires 22. The ends of the ground plate 21 in the Z direction are fixed to the laser chamber 10.

The fan 23 is a crossflow fan to circulate the laser gas in the laser chamber 10. The fan 23 is disposed such that its longitudinal direction is approximately parallel to the Z direction. The fan 23 is disposed opposite to the discharge space with respect to the ground plate 21. The fan 23 is rotationally driven by a motor 23a which is connected to the laser chamber 10, to generate the flow of the laser gas.

The laser gas blown out of the fan 23 flows into the discharge space. The direction of the laser gas flowing into the discharge space is approximately parallel to the H direction. The laser gas flown out of the discharge space may be drawn into the fan 23 through the heat exchanger 24. The heat exchanger 24 exchanges heat between a refrigerant supplied into the heat exchanger 24 and the laser gas.

The windows 21a and 21b are provided at the ends of the laser chamber 10. The light generated in the laser chamber 10 is emitted to the outside of the laser chamber 10 through the windows 21a and 21b.

The rear mirror 14 and the output coupling mirror 15 constitutes an optical resonator. The laser chamber 10 is provided on an optical path of the optical resonator. The rear mirror 14 includes a substrate formed of calcium fluoride (CaF₂) or the like which transmits the pulse laser light PL, and a high reflective film is formed on the substrate. The output coupling mirror 15 includes a substrate formed of calcium fluoride (CaF₂) or the like which transmits the pulse laser light PL, and a partially reflective film is formed on the substrate. The reflectance of the partially reflective film of the output coupling mirror 15 is in a range of 8% to 15%.

The light emitted from the laser chamber 10 makes round trips between the rear mirror 14 and the output coupling mirror 15, and is amplified every time the light passes through the discharge space. A part of the amplified light is emitted through the output coupling mirror 15, as the pulse laser light PL.

The pulse energy measurement unit 16 is provided on the optical path of the pulse laser light PL emitted through the output coupling mirror 15. The pulse energy measurement unit 16 includes a beam splitter 16a, a focusing optical system 16b, and an optical sensor 16c.

The beam splitter 16a transmits a part of the pulse laser light PL at high transmittance, and reflects the remaining part of the pulse laser light PL toward the focusing optical system 16b. The focusing optical system 16b concentrates the light reflected by the beam splitter 16a on a light reception surface of the optical sensor 16c. The optical sensor 16c detects pulse energy of the light concentrated on the light reception surface and outputs data on the detected pulse energy to the laser control unit 18.

The charger 11 is a DC (direct current) power supply device for charging a charging capacitor C₀ (described later) included in each PPM 12 at a constant charged voltage. Each PPM 12 includes a switch 12a controlled by the laser control unit 18. The switch 12a includes an insulated gate bipolar transistor (IGBT). When the switch 12a is turned from OFF to ON, the PPM 12 generates a high-voltage pulse using the electrical energy in the charging capacitor C₀ so that the high-voltage pulse is applied to the first discharge electrode 20a.

The plurality of PPMs 12 are arranged in the Z direction on the holder 28. At least one peaking capacitor 27 is electrically connected to each PPM 12. In this comparative example, two peaking capacitors 27 are connected in parallel to one PPM 12. The total number of the plurality of PPMs 12 is denoted by n. Hereinafter, each PPM 12 is referred to as a PPM(k). Here, k is 1, 2, . . . , or n. One or two or more peaking capacitors 27 which are connected to the PPM(k) are referred to as a Cp(k).

The laser control unit 18 transmits and receives various signals to and from an external device control unit 3 included in an external device such as an exposure device (not illustrated). For example, the laser control unit 18 receives an external trigger signal IR as a light emission trigger, and data on the target pulse energy Et from the external device control unit 3. The laser control unit 18 receives a pulse energy value measured by the pulse energy measurement unit 16. The external device may not be the exposure device. The external device may be a processing laser device, a laser annealing device, or a laser doping device.

The laser control unit 18 calculates a charged voltage V to be set at the charger 11 with reference to the data on the target pulse energy Et received from the external device control unit 3 and the measured pulse energy value received from the pulse energy measurement unit 16. The laser control unit 18 is connected to the synchronization control unit 17 to transmit the external trigger signal TR and a setting value of the charged voltage V to the synchronization control unit 17.

The synchronization control unit 17 is connected to the laser control unit 18, the charger 11, and the PPM(1) to PPM(n). The charger 11 receives the setting value of the charged voltage V through the synchronization control unit 17, and charges the charging capacitor C₀ included in each PPM(k) based on the setting value of the charged voltage V.

The synchronization control unit 17 generates n switch signals S(1) to S(n) based on the external trigger signal TR received from the laser control unit 18. The switch signal S(k) is input to the switch 12a included in the PPM(k).

1.1.2 Pulse Power Module

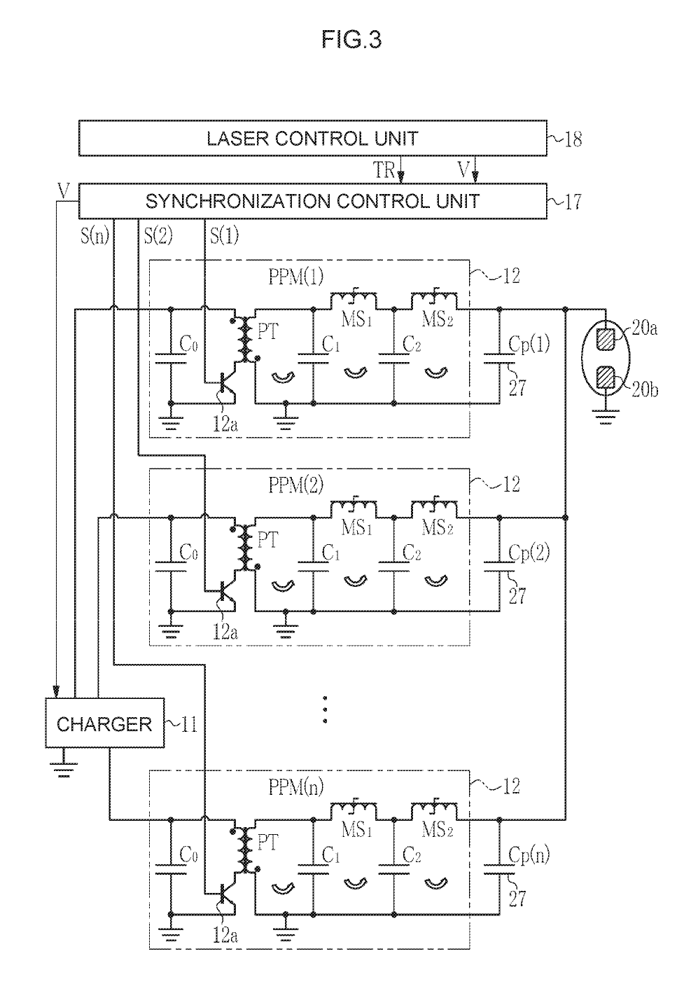

FIG. 3 illustrates configurations of the PPM(1) to PPM(n) illustrated in FIG. 1. The PPM(1) to PPM(n) have the same configurations with one another, and the configuration of one PPM(k) will be described. The PPM(k) includes the charging capacitor C₀, the switch 12a, a pulse transformer PT, a plurality of magnetic switches MS₁ and MS₂, and a plurality of capacitors C₁ and C₂. The pulse transformer PT, a plurality of magnetic switches MS₁ and MS₂ and the plurality of capacitors C₁ and C₂ form a pulse compression circuit.

The magnetic switches MS₁ and MS₂ each include a saturable reactor. Each of the magnetic switches MS₁ and MS₂ is switched to a low impedance state when the time integral of the voltage applied across the magnetic switch becomes a predetermined threshold determined by the properties of the magnetic switch.

The switch 12a in the PPM(k) receives a switch signal S(k) from the synchronization control unit 17. When the switch 12a receives the switch signal S(k), and is turned ON, electric current flows from the charging capacitor C₀ to a primary side of the pulse transformer PT.

The electric current flowing through the primary side of the pulse transformer PT causes electromagnetic induction to generate reverse electric current through a secondary side of the pulse transformer PT. The reverse electric current flowing through the secondary side of the pulse transformer PT causes a current pulse to flow in a capacitor C₁ to charge the capacitor C₁. At this time, the time integral of the voltage applied to the magnetic switch reaches the threshold. When the time integral of the voltage applied to the magnetic switch MS₁ reaches the threshold, the magnetic switch MS₁ is magnetically saturated and closed.

When the magnetic switch MS₁ is closed, the current pulse may flow from the capacitor C₁ to a capacitor C₂ to charge the capacitor C₂. At this time, the current pulse flowing through the capacitor C₂ has a shorter pulse width than the current pulse flowing through the capacitor C₁. Charging the capacitor C₂ allows the magnetic switch MS₂ to be magnetically saturated and closed.

When the magnetic switch MS₂ is closed, the current pulse flows from the capacitor C₂ to the Cp(k) which is the peaking capacitor 27 connected to the PPM(k), to charge the Cp(k). At this time, the current pulse flowing through the Cp(k) has a shorter pulse width than the current pulse flowing through the capacitor C₂. As described above, the current pulse sequentially flows from the capacitor C₁ to the capacitor C₂ and then from the capacitor C₂ to the Cp(k), so that the pulse width of the current pulse is compressed. Thus, compressing the pulse width of the current pulse is referred to as pulse compression.

When the voltage across the Cp(k) reaches a breakdown voltage of the laser gas, the laser gas is dielectrically broken down between the first and second discharge electrodes 20a and 20b. Thus, the laser gas is excited, and the ultraviolet laser light is emitted when the excited state returns to the ground state. Such a discharge operation is repeated with the switching operation of the switch 12a, resulting in the pulse laser light PL being emitted at a predetermined oscillation frequency.

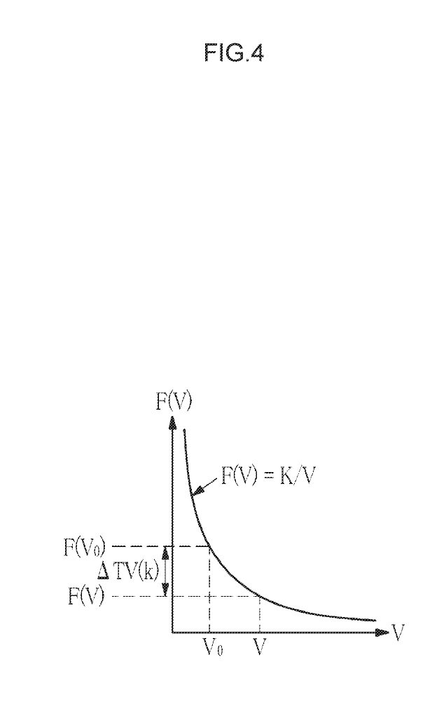

FIG. 4 is a graph showing a relationship between the charged voltage V of the PPM(k) and a required time F(V) from the time of inputting the switch signal S(k) to the PPM(k) to the time of applying the high voltage to the first discharge electrode 20a. The PPM(k) includes the pulse compression circuit (magnetic compression circuit), and the relationship between the required time F(V) and the charged voltage (V) is represented by the following formula (1).

F(V)=K/V (1)

Here, K is a constant value.

Accordingly, a time difference ΔTV(k) represented by the following formula (2) is generated between the required time F(V) when the charged voltage set at the PPM(k) is V and the required time F(V₀) when the charged voltage V is a reference voltage V₀.

ΔTV(k)=F(V₀)−F(V) (2)

Specifically, when the charged voltage V set at the PPM(k) is larger than the reference voltage V₀, the required time F(V) is shorter than the required time F(V₀) when the charged voltage V is a reference voltage V₀, by the time difference ΔTV(k),

1.1.3 Synchronization Control Unit

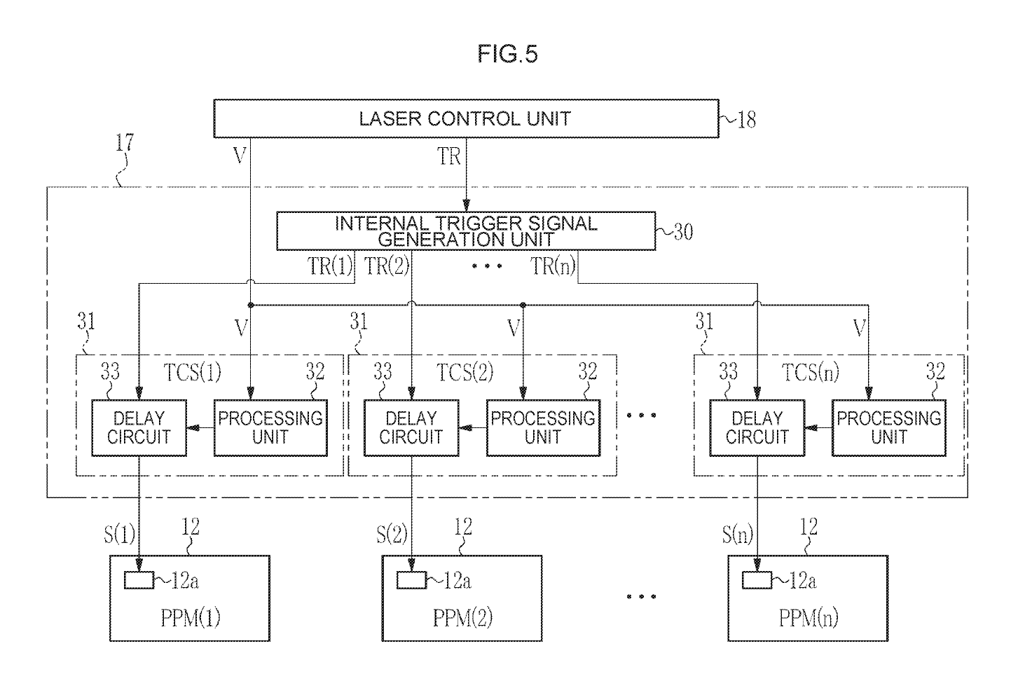

FIG. 5 illustrates a configuration of the synchronization control unit 17 illustrated in FIG. 1. The synchronization control unit 17 includes an internal trigger signal generation unit 30, and a plurality of trigger correction units (TCS) 31. Each of the trigger correction units 31 includes a processing unit 32 and a delay circuit 33.

The trigger correction unit 31 is provided for each PPM 12. In other words, the total number of trigger correction units 31 is n. Hereinafter, the trigger correction unit 31 corresponding to the PPM(k) is referred to as a TCS(k). The TCS(1) to TCS(n) have the same configurations with one another.

The internal trigger signal generation unit 30 is connected to the laser control unit 18 and the TCS(1) to TCS(n). Upon reception of the external trigger signal TR from the laser control unit 18, the internal trigger signal generation unit 30 generates an internal trigger signal TR(k) and inputs the internal trigger signal TR(k) to the delay circuit 33 in each TCS(k).

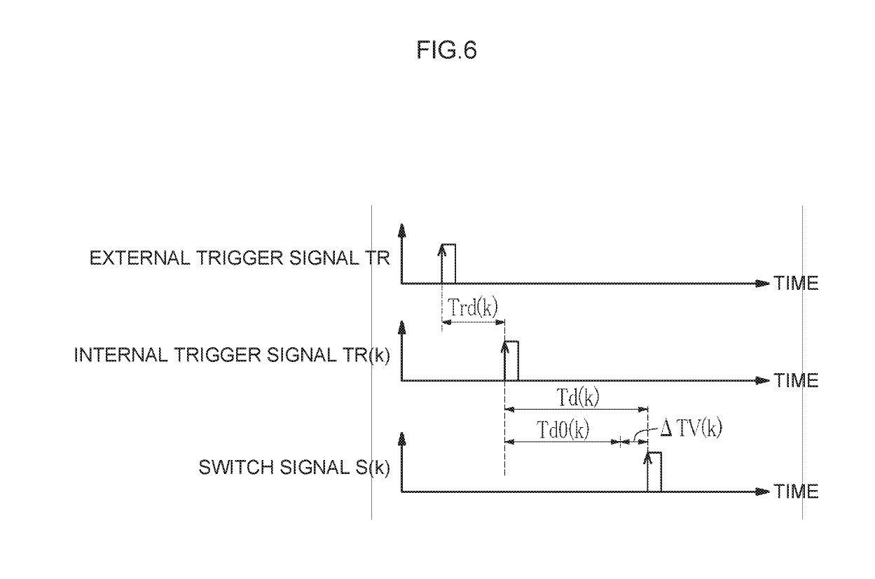

As illustrated in FIG. 6, the internal trigger signal generation unit 30 outputs the internal trigger signal TR(k) after a delay time Trd(k) has passed since the time of receiving the external trigger signal TR. Here, all of the delay times Trd(1) to Trd(n) have a reference delay time Trd0, and therefore are the same value. In other words, the internal trigger signal TR(k) is input to the delay circuit 33 in each TCS(k) at the same time.

The processing unit 32 in each TCS(k) is connected to the laser control unit 18 and the delay circuit 33 in the TCS(k). The processing unit 32 calculates the delay time Td(k) for delaying the internal trigger signal TR(k) based on the setting value of the charged voltage V received from the laser control unit 18, and inputs the calculated delay time Td(k) to the delay circuit 33. Specifically, the processing unit 32 determines the time difference ΔTV(k) based on the above-described formula (2). The processing unit 32 may store a function representing the required time F(V) as table data, and determine the time difference ΔTV(k) based on the table data.

The processing unit 32 determines the time difference ΔTV(k), and then calculates the delay time Td(k) based on the following formula (3).

Td(k)=Td0(k)+ΔTV(k) (3)

Here, Td0(k) is a reference delay time when the charged voltage V is a reference voltage V₀. In other words, the delay time Td(k) results from adding the correction time ΔTV(k) determined based on the above-described formula (2) to the reference delay time Td0(k).

The delay circuit 33 acquires and holds the data on the delay time Td(k) calculated by the processing unit 32. As illustrated in FIG. 6, upon reception of the internal trigger signal TR(k) from the internal trigger signal generation unit 30, the delay circuit 33 inputs a signal obtained by delaying the internal trigger signal TR(k) by the delay time Td(k) as a switch signal S(k) to the corresponding PPM12. Thereby, the required time from the timing when the laser control unit 18 receives the external trigger signal TR to the timing when the PPM(k) applies the high voltage to the first discharge electrode 20a is approximately constant.

1.2 Operation

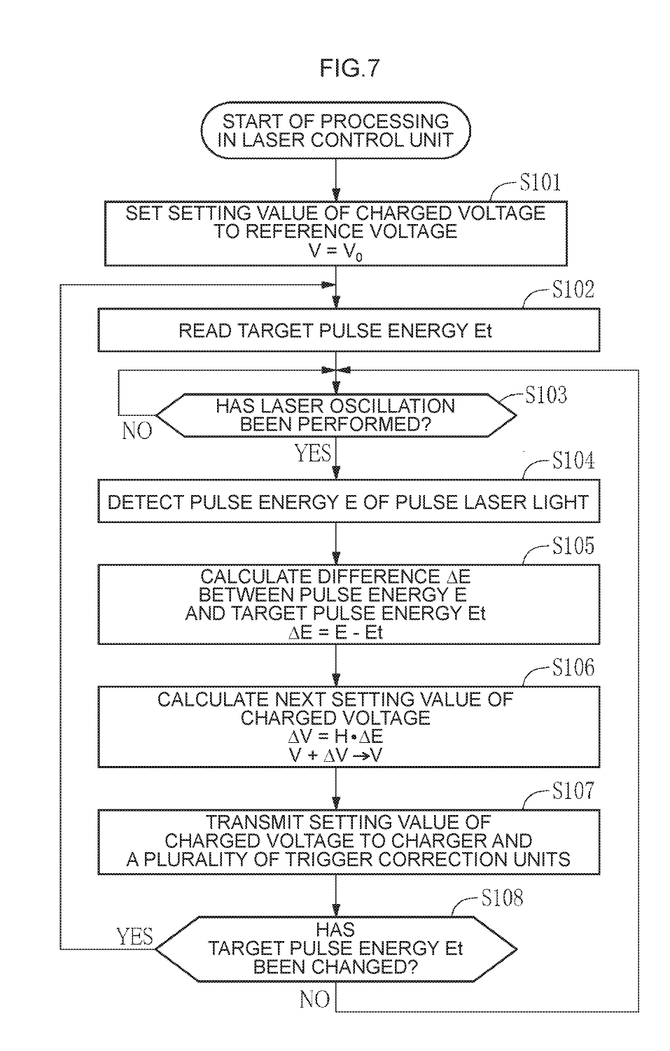

The operation of the gas laser device 2 according to the comparative example will he described with reference to FIG. 7 to FIG. 9.

1.2.1 Processing in Laser Control Unit

FIG. 7 is a flowchart illustrating a process performed by the laser control unit 18. The laser control unit 18 calculates a charged voltage V to be set at the charger 11 based on the target pulse energy Et through the following process.

First, in step S 101, the laser control unit 18 sets a setting value of the charged voltage V to a reference voltage V₀ as an initial value. Next, in step S102, the laser control unit 18 reads the data on the target pulse energy Et transmitted from the external device control unit 3.

Next, in step S103, upon reception of an external trigger signal TR from the external device control unit 3, the laser control unit 18 transmits the external trigger signal TR to the synchronization control unit 17, and determines whether the gas laser device 2 has performed laser oscillation. If the gas laser device 2 has not performed laser oscillation (S103: NO), the laser control unit 18 waits until the gas laser device 2 performs laser oscillation. If the gas laser device 2 has performed laser oscillation (S103: YES), the laser control unit 18 proceeds to step S104.

In step S104, the laser control unit 18 detects pulse energy E of the pulse laser light PL emitted from the gas laser device 2. The pulse energy E is measured by the pulse energy measurement unit 16.

Next, in step S105, the laser control unit 18 calculates a difference ΔE between the measured pulse energy E and the target pulse energy Et by the following formula (4).

ΔE=E−Et (4)

Next, in step S106, the laser control unit 18 calculates a change amount ΔV in the setting value of the charged voltage V based on the difference ΔE by the following formula (5).

ΔV=H·ΔE (5)

Here, H is a proportional constant. The change amount ΔV represents a change amount in the setting value of the charged voltage V which is set to make the difference ΔE zero. The laser control unit 18 calculates a next setting value by adding the change amount ΔV to the present setting value of the charged voltage V.

Next, in step S107, the laser control unit 18 transmits the setting value of the charged voltage V which has been calculated in step S106, to the charger 11 and the plurality of trigger correction units 31.

Next, in step S108, the laser control unit 18 determines whether the target pulse energy Et transmitted from the external device control unit 3 has been changed. If the target pulse energy Et has been changed (S108: YES), the laser control unit 18 returns to step S102. If the target pulse energy Et has not been changed (S108: NO), the laser control unit 18 returns to step S103. The above-described process is repeatedly performed.

1.2.2 Processing in Trigger Correction Unit

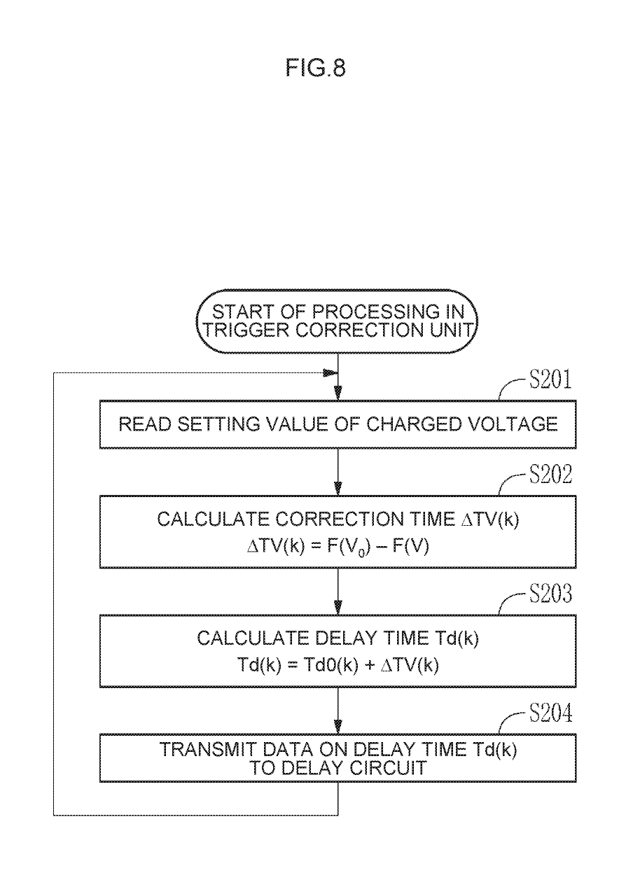

FIG. 8 is a flowchart illustrating a process performed by a trigger correction unit 31. Each of the trigger correction units 31 calculates, in the following process, the delay time Td(k) to correct the internal trigger signal TR(k) when the setting value of the charged voltage V has been transmitted from the laser control unit 18 in step S107 illustrated in FIG. 7.

First, in step S201, the processing unit 32 included in each TCS(k) reads the setting value of the charged voltage V transmitted from the laser control unit 18. Next, in step S202, the processing unit 32 calculates the correction time ΔTV(k) based on the above-described formula (1) and formula (2). Next, in step S203, the processing unit 32 calculates the delay time Td(k) based on the above-described formula (3). In step S204, the processing unit 32 transmits the data on the calculated delay time Td(k) to the delay circuit 33. Then, the processing unit 32 returns to step S201. The above-described process is repeatedly performed.

Upon reception of the internal trigger signal TR(k) from the internal trigger signal generation unit 30, the delay circuit 33 delays the internal trigger signal TR(k) by the delay time Td(k), and inputs the delayed internal trigger signal TR(k), as a switch signal S(k), to the PPM(k).

1.2.3 Overall Operation of Gas Laser Device

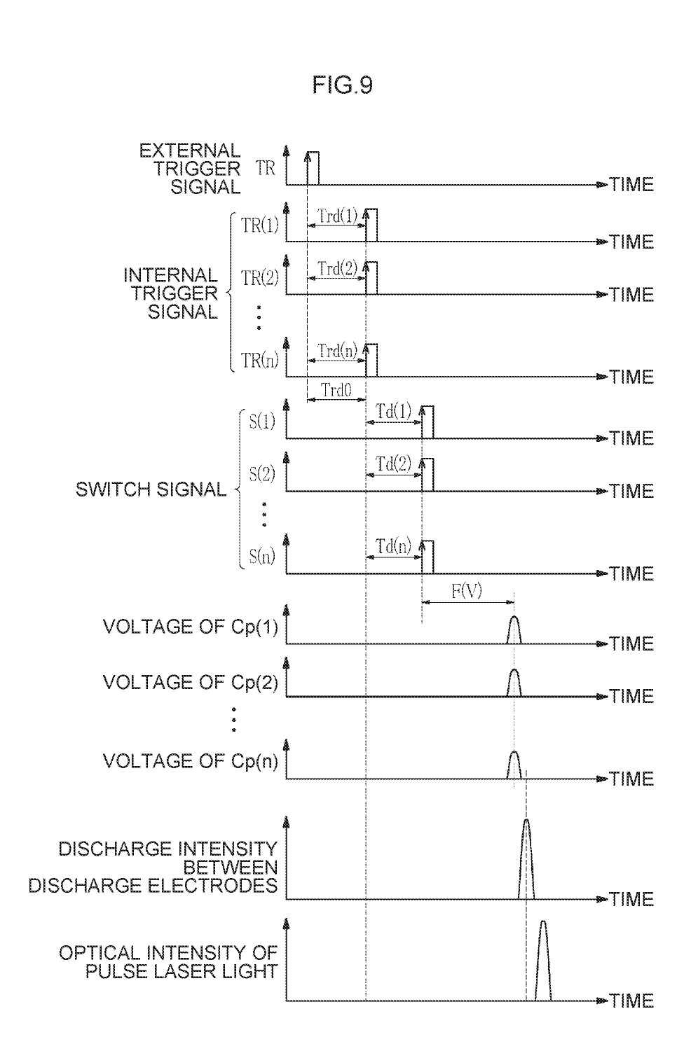

FIG. 9 is a timing chart in the gas laser device 2 according to the comparative example. The overall operation of the gas laser device will be described with reference to FIG. 9.

Upon reception of the data on the target pulse energy Et from the external device control unit 3, the laser control unit 18 calculates the setting value of the charged voltage V so that the pulse energy E of the pulse laser light PL approaches the target pulse energy Et, and transmits the calculated setting value of the charged voltage V to the charger 11 through the synchronization control unit 17.

In the synchronization control unit 17, the processing unit 32 in each TCS(k) calculates the delay time Td(k) based on the setting value of the charged voltage V, and transmits the data on the delay time Td(k) to the delay circuit 33. Upon reception of the external trigger signal TR from the external device control unit 3 through the laser control unit 18, the internal trigger signal generation unit 30 in the synchronization control unit 17 generates the internal trigger signal TR(k) to input to the delay circuit 33 in each TCS(k). The internal trigger signal TR(k) input to the delay circuit 33 in each TCS(k) is delayed by the delay time Td(k), and is input to the switch 12a in the PPM(k) as a switch signal S(k).

As illustrated in FIG. 9, the switch signals S(1) to S(n) are input to the respective switches 12a in the PPM(1) to PPM(n) at approximately the same time, so that the respective switches 12a are turned ON at approximately the same time. The Cp(1) to Cp(n) are charged by the current pulses pulse-compressed by the PPM(1) to PPM(n) at approximately the same time, and apply the high voltage to the first discharge electrode 20a at approximately the same time.

As a result, dielectric breakdown occurs in the laser gas, and pulse discharge is generated in the discharge space. This pulse discharge results in excitation of the laser gas, and the ultraviolet laser light is emitted when the excited state returns to the ground state. The ultraviolet laser light is subjected to laser oscillation by the optical resonator, and the pulse laser light PL is emitted from the output coupling mirror 15. The pulse energy E of the emitted pulse laser light PL is measured by the pulse energy measurement unit 16.

The laser control unit 18 reads the pulse energy E of the pulse laser light measured by the pulse energy measurement unit 16, and calculates the setting value of the charged voltage V so that the pulse energy E of the pulse laser light PL approaches the target pulse energy Et. The above-described steps are repeated.

As described above, the synchronization control unit 17 controls the timings of turning ON the switches 12a in the PPM(1) to PPM(n) based on the charged voltage V of the charger 11 so that the timings of charging the Cp(1) to Cp(n) approximately coincide with one another.

1.3 Problem

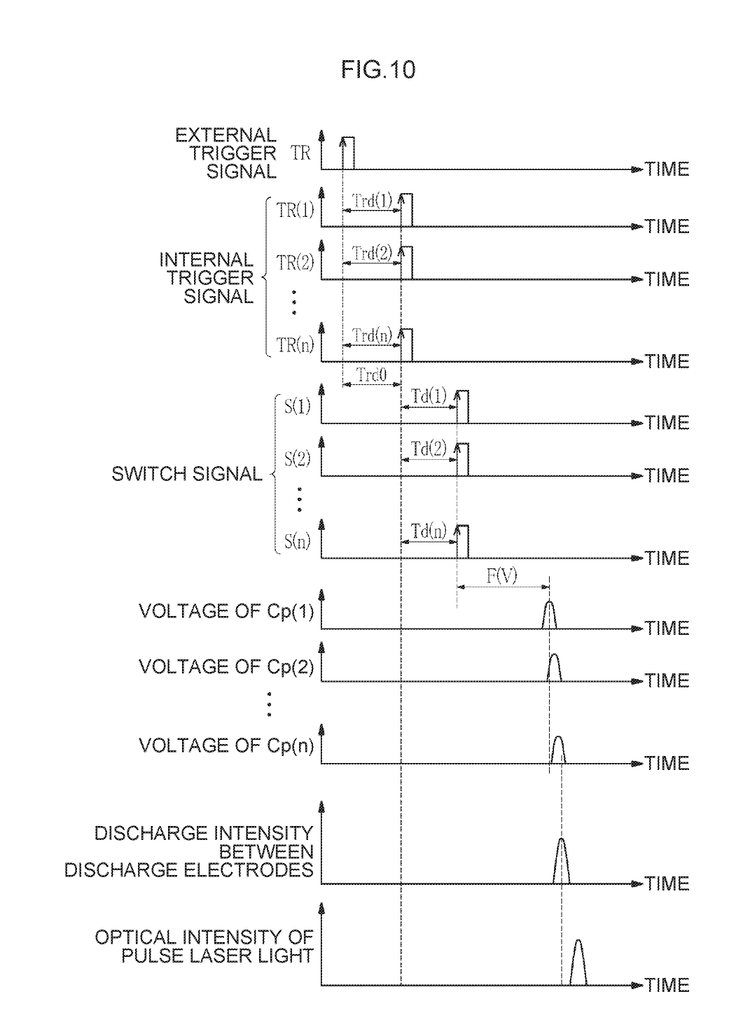

In the gas laser device 2 according to the comparative example, the timings of charging the Cp(1) to Cp(n) are so controlled as to approximately coincide with one another, but even if the control is thus performed, the timings of charging the Cp(1) to Cp(n) may be shifted from one another as illustrated in FIG. 10. When the charging timings are shifted from one another, the timings of applying the high voltage to the first discharge electrode 20a from the PPM(1) to PPM(n) are shifted from one another, thereby reducing the discharge intensity. As a result, the light emission intensity of the pulse laser light PL is reduced. To prevent the light emission intensity of the pulse laser light PL from being reduced, the timings of charging the Cp(1) to Cp(n) need to coincide with one another with an accuracy of several nanoseconds or less.

The shifts in the charging timing of about several nanoseconds may be caused by individual difference, temperature difference, or the like in the PPM(1) to PPM(n). For example, the charging timing depends on the temperature of each constituent element of the PPM(1) to PPM(n), and therefore the shifts in the timings of charging the Cp(1) to Cp(n) are caused by the temperature difference. If the temperature of each constituent element of the PPM(1) to PPM(n) can be directly measured, or the temperature changes can be accurately predicted, the shifts in the charging timing can be reduced to some extent, but it is practically difficult to directly measure or predict the temperature. It is also difficult to eliminate the individual difference among the PPM(1) to PPM(n).

Accordingly, there are problems in that in the gas laser device 2 according to the comparative example, the shifts in the charging timing of Cp(1) to Cp(n) cannot be suppressed, and the resulting reduction in the light emission intensity of the pulse laser light PL cannot he suppressed.

### 2. First Embodiment

A gas laser device according to a first embodiment of the present disclosure will be described below. The gas laser device according to the first embodiment has the same configuration as the gas laser device 2 according to the comparative example except that the gas laser device according to the first embodiment includes an output pulse sensor, and the trigger correction unit having a different configuration from that according to the comparative example. Hereinafter, the constituent elements that are the same as the constituent elements of the gas laser device 2 according to the comparative example are denoted by the same reference signs, and the description thereof is appropriately omitted.

2.1 Configuration

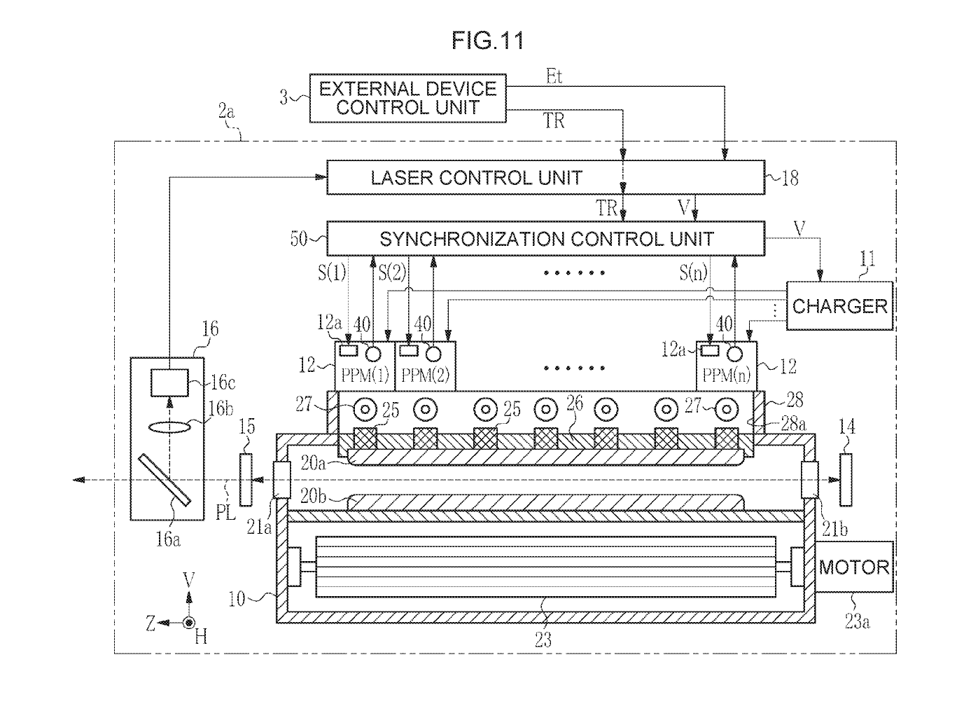

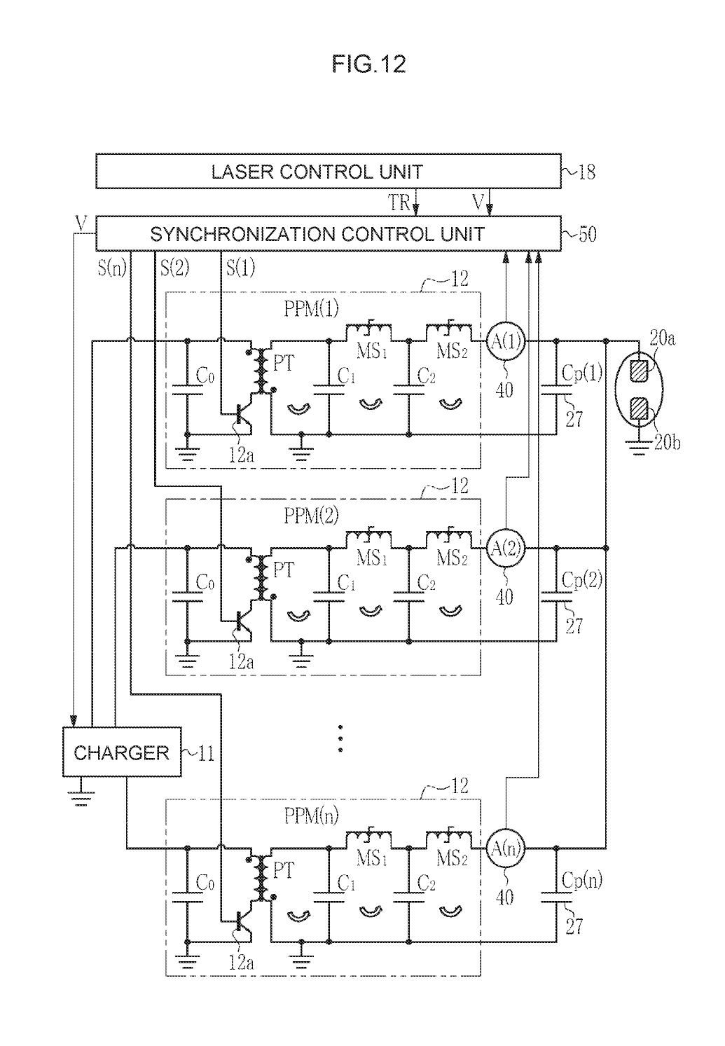

FIG. 11 schematically illustrates a configuration of a gas laser device 2a according to the first embodiment. FIG. 12 illustrates configurations of a PPM(1) to a PPM(n) which are illustrated in FIG. 11. In the first embodiment, an output pulse sensor 40 is provided between the PPM 12 and the peaking capacitor 27. The output pulse sensor 40 is provided for each PPM 12. Hereinafter, the output pulse sensor 40 disposed between the PPM(k) and the Cp(k) is referred to as an A(k).

In the first embodiment, the output pulse sensor A(k) is a current sensor for detecting a current pulse as an output pulse. The output pulse sensor A(k) is connected between the magnetic switch MS₂ and the peaking capacitor 27. Upon detection of the current pulse, the output pulse sensor A(k) inputs a detection signal D1(k) to a synchronization control unit 50.

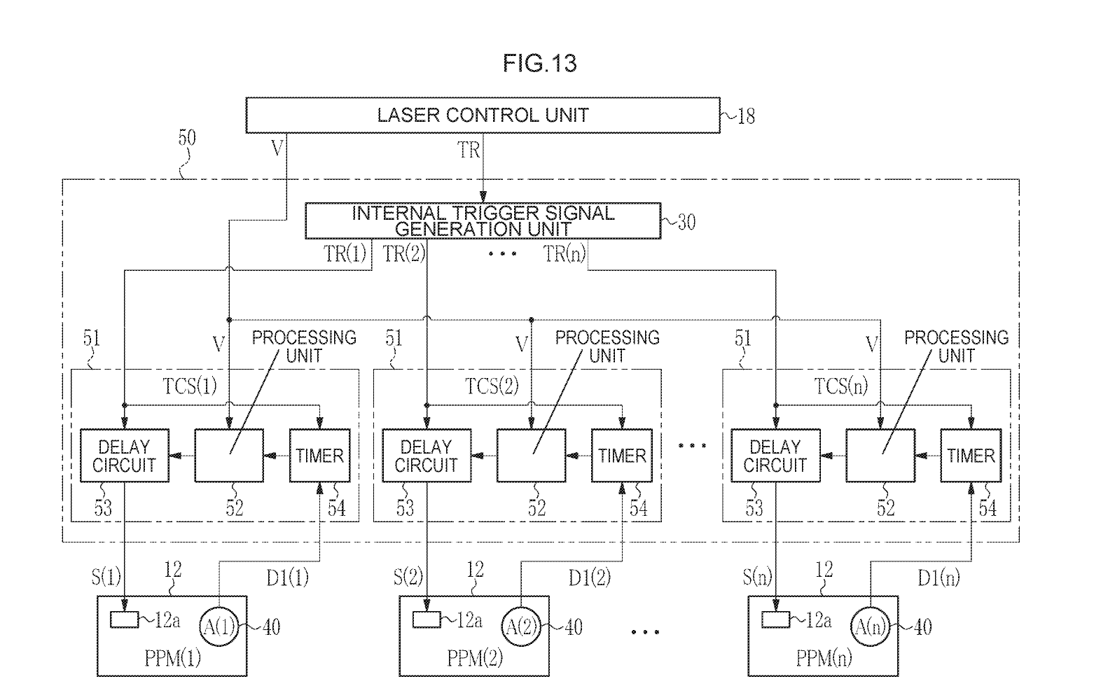

FIG. 13 illustrates a configuration of a synchronization control unit 50 according to the first embodiment. The synchronization control unit 50 includes an internal trigger signal generation unit 30, and a plurality of trigger correction units (TCS) 51. The synchronization control unit 50 controls the timings of switch signals S(1) to S(n) to be input to the PPM(1) to PPM(n), respectively. All of or part of the synchronization control unit 50 is composed of an FPGA (Field Programmable Gate Array) enabling a high speed processing operation. Hereinafter, the trigger correction unit 51 corresponding to the PPM(k) is referred to as a TCS(k).

The internal trigger signal generation unit 30 has the same configuration as the internal trigger signal generation unit 30 according to the comparative example. Upon reception of the external trigger signal TR from the laser control unit 18, the internal trigger signal generation unit 30 generates an internal trigger signal TR(k) and inputs the generated internal trigger signal TR(k) to the TCS(k).

Each TCS(k) includes a processing unit 52, a delay circuit 53, and a timer 54. The internal trigger signal TR(K) is input to the delay circuit 53 and the timer 54 from the internal trigger signal generation unit 30, at the same time. The detection signal D1(k) is input to the timer 54 in the TCS(k) from the output pulse sensor A(k).

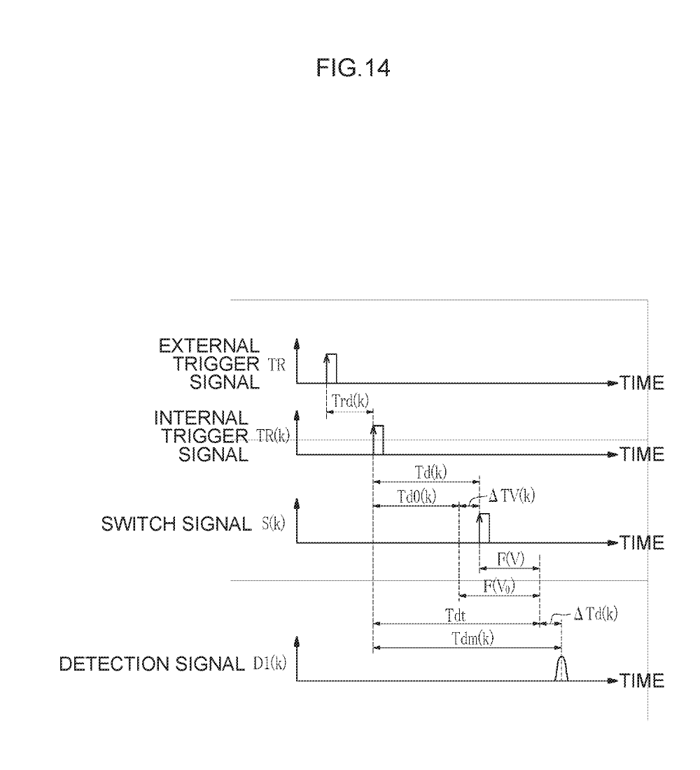

The timer 54 starts clocking upon input of the internal trigger signal TR(k) and stops clocking upon input of the detection signal D1(k). In other words, the timer 54 measures a time Tdm(k) required from the input of the internal trigger signal TR(k) to the input of the detection signal D1(k), as illustrated in FIG. 14. The timer 54 inputs the data on the measured time Tdm(k) to the processing unit 52.

The processing unit 52 in the TCS(k) calculates the delay time Td(k) for delaying the internal trigger signal TR(k) based on the setting value of the charged voltage V received from the laser control unit 18, and inputs the calculated delay time Td(k) to the delay circuit 53. Specifically, the processing unit 52 determines the time difference ΔTV(k) based on the above-described formula (2). The processing unit 52 determines the time difference ΔTV(k), and then calculates the delay time Td(k) based on the above-described formula (3).

The processing unit 52 in the TCS(k) corrects the delay time Td(k) based on the data on the measured time Tdm(k) input from the timer 54. Thereby, the timing of the switch signal S(k) is corrected.

As described above, the synchronization control unit 50 and the laser control unit 18 constitute a control unit for controlling the timing of the switch signal S(k) based on the detection result of the output pulse sensor A(k).

2.2 Operation

2.2.1 Processing in Laser Control Unit

The process performed by the laser control unit 18 in the first embodiment is similar to that described using the flowchart illustrated in FIG. 7, and the description thereof is omitted.

2.2.2 Processing in Trigger Correction Unit

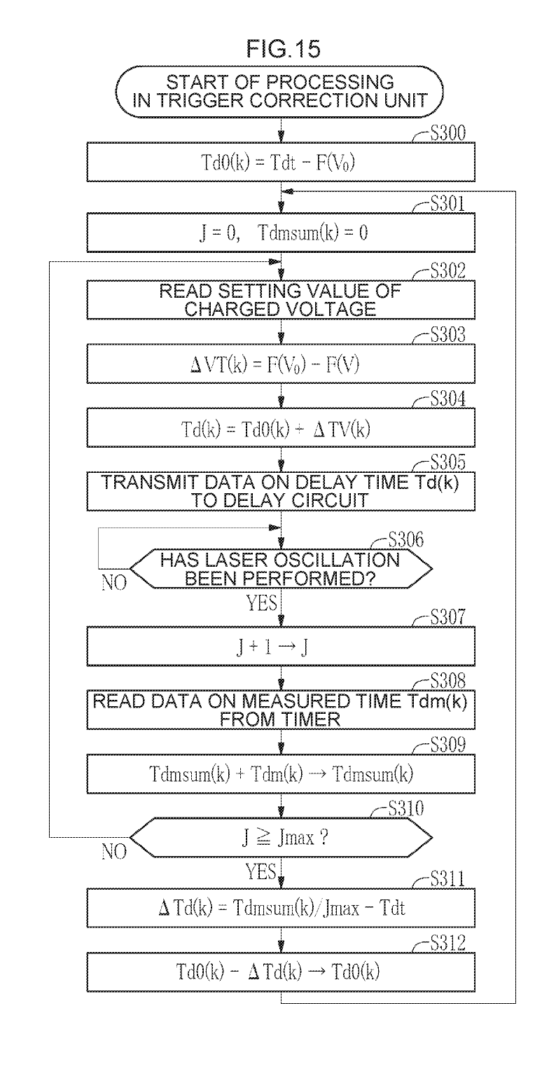

FIG. 15 is a flowchart illustrating a process performed by each TCS(k). Each TCS(k) calculates the delay time Td(k) to correct the internal trigger signal TR(k) in the following process when the setting value of the charged voltage V has been transmitted from the laser control unit 18 in step S107 illustrated in FIG. 7.

First, in step S300, the processing unit 52 in each TCS(k) sets a reference delay time Td0(k) to an initial value as follows.

Td0(k)=Tdt−F(V₀)

Here, Tdt is a target value of the measured time Tdm(k). F(V₀) is the above-described required time F(V) when the charged voltage V is the reference voltage V₀. The relationship among the reference delay time Td0(k), the target value Tdt, and the required time F(V₀) is illustrated in FIG. 14.

Next, in step S301, the processing unit 52 resets a variable as follows.

J=0

Tdmsum(k)=0

Here, J is a counter for counting the number of oscillation pulses. Tdmsum(k) is a total value for calculating the average value of the measured time Tdm(k) measured by the timer 54.

Next, in step S302, the processing unit 52 reads the setting value of the charged voltage V transmitted from the laser control unit 18. Next, in step S303, the processing unit 52 calculates the correction time ΔTV(k) based on the above-described formula (1) and formula (2). Next, in step S304, the processing unit 52 calculates the delay time Td(k) based on the above-described formula (3). Next, in step S305, the processing unit 52 transmits the data on the calculated delay time Td(k) to the delay circuit 53.

Next, in step S306, the processing unit 52 determines whether the gas laser device 2a has performed laser oscillation. Whether the gas laser device 2a has performed laser oscillation is determined based on whether the timer 54 has received the detection signal D1(k) from the output pulse sensor A(k). If the gas laser device 2a has performed laser oscillation (S306: YES), the processing unit 52 proceeds to step S307. If the gas laser device 2a has not performed laser oscillation (S306: NO), the processing unit 52 waits until the gas laser device 2a performs laser oscillation.

In step S307, the processing unit 52 adds 1 to the present value of the counter J to update the value of J. Next, in step S308, the processing unit 52 receives the data on the measured time Tdm(k) from the timer 54. Next, in step S309, the processing unit 52 adds the measured time Tdm(k) to the present total value Tdmsum(k) to update the total value Tdmsum(k).

Next, in step S310, the processing unit 52 determines whether the value of the counter J has reached a predetermined value Jmax representing the number of samples. If the value of the counter J has not reached the predetermined value Jmax (S310: NO), the processing unit 52 returns to step S302. If the value of the counter J has reached the predetermined value Jmax (S310: YES), the processing unit 52 proceeds to step S311.

In step S311, the processing unit 52 calculates the difference ΔTd(k) between the average value of the measured time Tdm(k) and the target value Tdt. The difference ΔTd(k) is calculated by the following formula (6).

ΔTd(k)=Tdmsum(k)/Jmax−Tdt (6)

Next, in step S312, the processing unit 52 calculates a new reference delay time Td0(k) which is a value obtained by subtracting the difference ΔTd(k) from the reference delay time Td0(k). Thus, after correcting the reference delay time Td0(k), the processing unit 52 returns to step S301. The above-described process is repeated.

Upon reception of the internal trigger signal TR(k) from the internal trigger signal generation unit 30, the delay circuit 53 in the TCS(k) delays the internal trigger signal TR(k) by the delay time Td(k), and inputs the delayed internal trigger signal TR(k) to the PPM(k) as a switch signal S(k).

As described above, in steps S302 to S305, a first correction process (jitter correction process) for correcting the timing of the switch signal S(k) is performed based on the charged voltage V. In steps S306 to S312, a second correction process (drift correction process) for correcting the timing of the switch signal S(k) is performed based on the detection result of the output pulse sensor A(k).

It is preferable that the number of samples Jmax is 200 or more and 10,000 or less. In other words, it is preferable that the frequency of the second correction process is lower than the frequency of the first correction process.

2.2.3 Overall Operation of Gas Laser Device

Hereinafter, the overall operation of the gas laser device 2a according to the first embodiment will be described. Upon reception of the data on the target pulse energy Et from the external device control unit 3, the laser control unit 18 calculates the setting value of the charged voltage V so that the pulse energy E of the pulse laser light PL approaches the target pulse energy Et, and transmits the calculated setting value of the charged voltage V to the charger 11 through the synchronization control unit 50.

In the synchronization control unit 50, the processing unit 52 in each TCS(k) calculates the delay time Td(k) based on the setting value of the charged voltage V and the reference delay time Tdm(k), and transmits the data on the delay time Td(k) to the delay circuit 53.

Upon reception of the external trigger signal TR from the external device control unit 3 through the laser control unit 18, the internal trigger signal generation unit 30 in the synchronization control unit 50 generates the internal trigger signal TR(k) to input to the delay circuit 53 and the timer 54 in each TCS(k). Upon reception of the internal trigger signal TR(k), the timer 54 is reset and starts clocking. The internal trigger signal TR(k) input to the delay circuit 53 in each TCS(k) is delayed by the delay time Td(k), and is input to the switch 12a in the PPM(k) as a switch signal S(k).

The switch signals S(1) to S(n) are input to the respective switches 12a in the PPM(1) to PPM(n) at approximately the same time, so that the respective switches 12a are turned ON at approximately the same time. The current pulse pulse-compressed by the PPM(k) is output to the Cp(k) as an output pulse.

At this time, the output pulse from the PPM(k) is detected by the output pulse sensor A(k) provided in a subsequent state of the PPM(k). Upon detection of the output pulse, the output pulse sensor A(k) transmits the detection signal D1(k) to the tinier 54 in the TCS(k). Upon reception of the detection signal D1(k), the timer 54 stops clocking, and inputs the measured time Tdm(k) from the input of the internal trigger signal TR(k) to the input of the detection signal D1(k) to the processing unit 52. Upon reception of the measured time Tdm(k), the processing unit 52 performs the above-described process, calculates the difference ΔTd(k) between the average value of the measured time Tdm(k) and the target value Tdt, and corrects the reference delay time Td0(k).

The Cp(k) is charged by the current pulse, resulting in the high voltage being applied between the first discharge electrode 20a and the second discharge electrode 20b. As a result, dielectric breakdown occurs in the laser gas, and pulse discharge is generated in the discharge space. This pulse discharge results in excitation of the laser gas, and the ultraviolet laser light is emitted when the excited state returns to the ground state. The ultraviolet laser light is subjected to laser oscillation by the optical resonator, and the pulse laser light PL is emitted from the output coupling mirror 15. The pulse energy E of the emitted pulse laser light PL is measured by the pulse energy measurement unit 16.

The laser control unit 18 reads the pulse energy E of the pulse laser light measured by the pulse energy measurement unit 16, and calculates the setting value of the charged voltage V so that the pulse energy E of the pulse laser light PL approaches the target pulse energy Et. The above-described steps are repeated.

2.3 Effect

In the first embodiment, the reference delay time Td0(k) is corrected based on the difference ΔTd(k) between the average value of the measured time Tdm(k) and the target value Tdt, so that the delay time Td(k) calculated in the next cycle is corrected by the difference ΔTd(k). Thereby, the measured time Tdm(k) approaches the target value Tdt. The above-described process is individually performed by each TCS(k), so that the measured time Tdm(k) measured by each timer 54 is approximately the same.

As a result, the timings of detecting the output pulse by the output pulse sensors A(1) to A(n) approximately coincide with one another, thereby suppressing the shifts in the timings of charging the Cp(1) to Cp(n). Accordingly, according to the first embodiment, the reduction in the light emission intensity of the pulse laser light PL caused by the shifts in the timings of charging the Cp(1) to Cp(n) can be suppressed.

The gas laser device 2a includes n PPMs 12, thereby increasing the output energy by a factor of n. For example, if the output energy of one PPM 12 is 10 J, the gas laser device 2a has performance equivalent to that of the gas laser device which includes a high output PPM having the output energy of n×10 J.

In the first embodiment, a plurality of PPMs 12 are connected in parallel with only one charger 11, so that the charged voltage V applied to the plurality of PPMs 12 is approximately the same. Thus, the difference in the charged voltage V between the plurality of PPMs 12 is small, so that the influence on the charging timing is small. However, if a large number of PPMs 12 causes too large output of the charger 11, a plurality of chargers may be provided, so that the charged voltage V can be supplied to each PPM 12 from each of the chargers.

### 3. Second Embodiment

A gas laser device according to a second embodiment of the present disclosure will be described below. The gas laser device according to the second embodiment enables a pulse width of the pulse laser light to be controlled with high accuracy by making the timing of the switch signal different for each PPM. Hereinafter, the constituent elements that are the same as the constituent elements of the gas laser device 2a according to the first embodiment are denoted by the same reference signs, and the description thereof is appropriately omitted.

3.1 Configuration

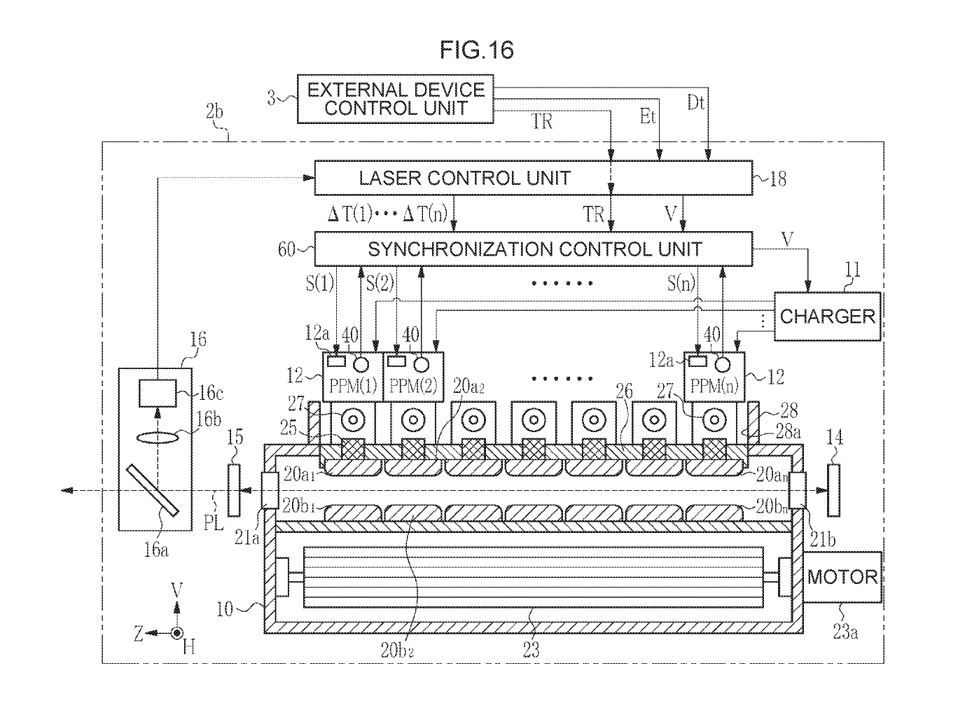

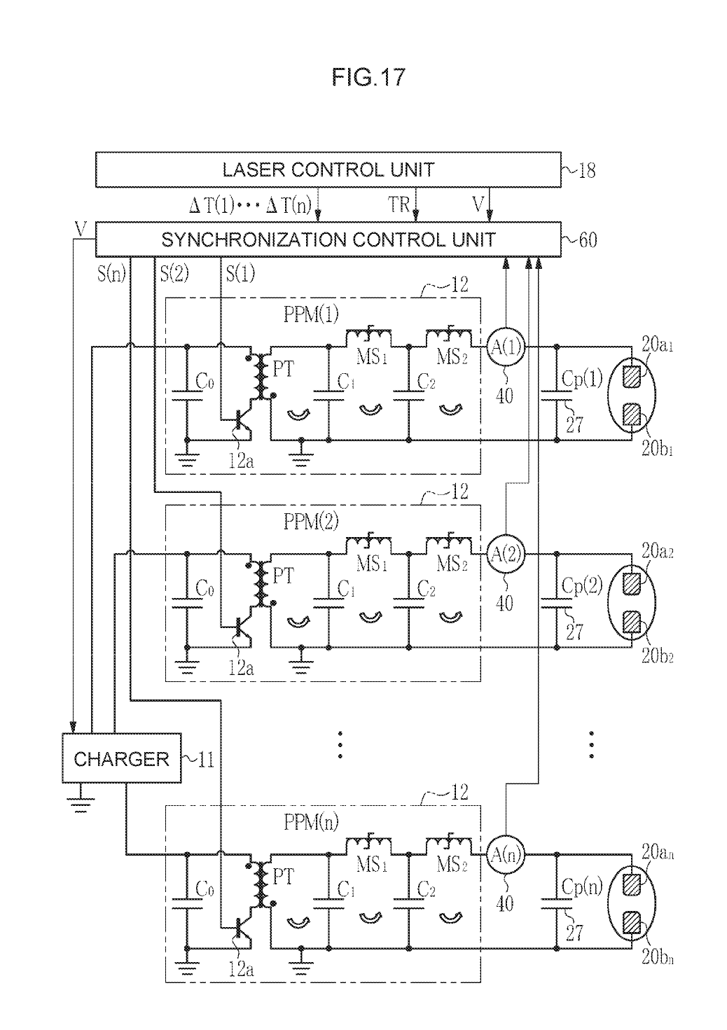

FIG. 16 schematically illustrates a configuration of a gas laser device 2b according to the second embodiment. FIG. 17 illustrates configurations of a PPM(1) to a PPM(n) which are illustrated in FIG. 16. In the second embodiment, in addition to the external trigger signal TR and the data on the target pulse energy Et, the data on the target pulse width Dt is transmitted to the laser control unit 18 from the external device control unit 3.

The second embodiment is different from the first embodiment in that a plurality of first discharge electrodes 20a₁ to 20aₙ and a plurality of second discharge electrodes 20b₁ to 20bₙ are provided in the laser chamber 10. To the PPM(k), the first discharge electrode 20aₖ and the second discharge electrode 20bₖ are provided. This is because the first discharge electrode 20aₖ connected to the PPM(k) individually discharges. Here, k is 1, 2, . . . , or n.

All of the second discharge electrodes 20b₁ to 20bₙ are ground electrodes, and therefore it is not necessary that the gas laser device 2b is provided with the plurality of second discharge electrodes, and it is merely required to provide one second discharge electrode 20b like the gas laser device 2a according to the first embodiment.

The PPM 12 has the same configuration as the first embodiment. The PPM(k) is connected to the corresponding Cp(k) through the output pulse sensor A(k). The Cp(k) is connected to the first and second discharge electrodes 20aₖ, 20bₖ.

In the second embodiment, the laser control unit 18 calculates time difference data ΔT(1) to ΔT(n) for determining the timings of the switch signals S(1) to S(n) based on the data on the target pulse width Dt input from the external device control unit 3, and transmits the calculated time difference data to a synchronization control unit 60.

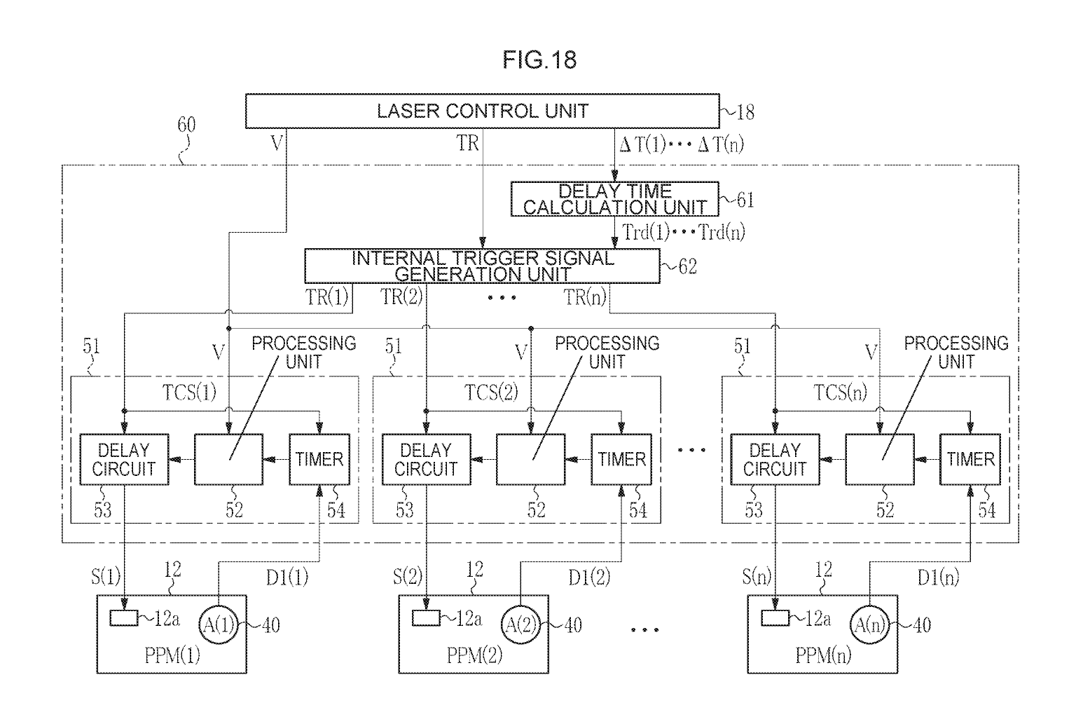

FIG. 18 illustrates a configuration of a synchronization control unit 60 according to the second embodiment. The synchronization control unit 60 includes a delay time calculation unit 61, an internal trigger signal generation unit 62, and a plurality of trigger correction units 51. The trigger correction unit 51 has the same configuration as the first embodiment. The delay time calculation unit 61 calculates delay times Trd(1) to Trd(n) based on the time difference data ΔT(1) to ΔT(n) input from the laser control unit 18, and inputs the calculated delay times to the internal trigger signal generation unit 62.

Upon reception of the external trigger signal TR from the laser control unit 18, the internal trigger signal generation unit 62 generates an internal trigger signal TR(k) and inputs the internal trigger signal TR(k) to the TCS(k). The internal trigger signal generation unit 62 generates the internal trigger signal TR(k) obtained by delaying the external trigger signal TR according to the delay time Trd(k) input from the delay time calculation unit 61.

The other configurations of the gas laser device 2b according to the second embodiment are the same as those of the gas laser device 2a according to the first embodiment.

3.2 Operation

3.2.1 Calculation Process of Time Difference Data

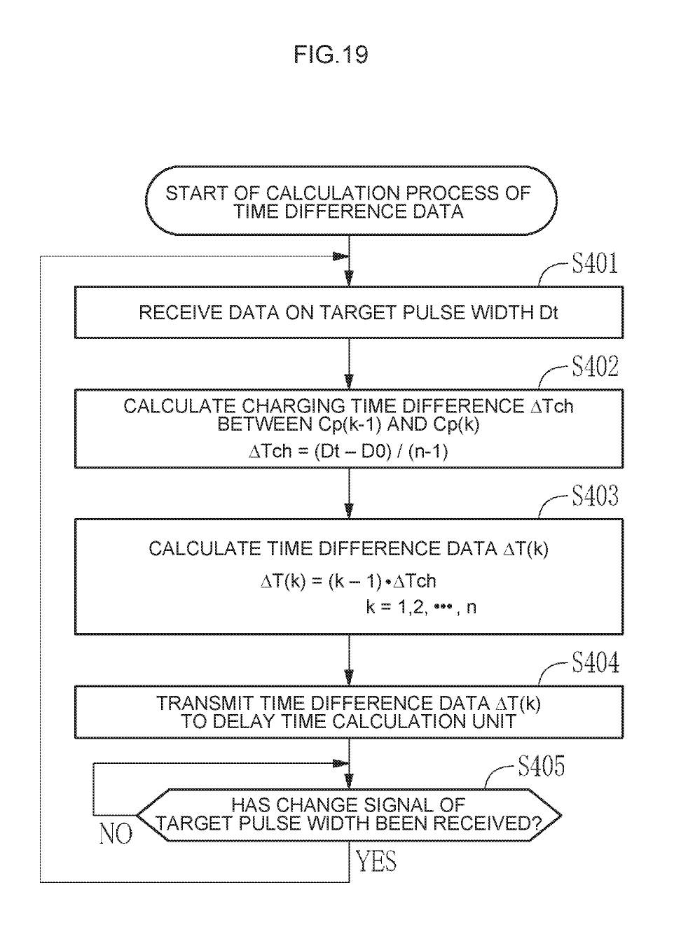

In the second embodiment, the laser control unit 18 performs a calculation process of the time difference data ΔT(k) illustrated in FIG. 19, in addition to the setting process of the charged voltage V illustrated in FIG. 7 in the comparative example. Hereinafter, the calculation process of the time difference data ΔT(k) will be described with reference to a flowchart illustrated in FIG. 19.

First, in step S401, the laser control unit 18 receives the data on the target pulse width Dt from the external device control unit 3. Next, in step S402, the laser control unit 18 calculates a charging time interval ΔTch required for the pulse width of the pulse laser light PL to be the target pulse width Dt based on the following formula (7). This charging time interval ΔTch refers to a charging timing difference between the Cp(k−1) and the Cp(k) which are adjacent to each other.

ΔTch=(Dt−D0)/(n−1) (7)

Here, D0 is a pulse width of the pulse laser light PL when all of the Cp(1) to Cp(n) have been charged at the same time. D0 is determined in advance experimentally and theoretically.

Next, in step S403, the laser control unit 18 calculates the time difference data ΔT(k) based on the following formula (8).

ΔT(k)=(k=1)·ΔTch (8)

Next, in step S404, the laser control unit 18 transmits the calculated time difference data ΔT(k) to the delay time calculation unit 61 in the synchronization control unit 60. Next, in step S405, the laser control unit 18 determines whether a change signal of the target pulse width Int has been received from the external device control unit 3. If the change signal has not been received (S405: NO), the laser control unit 18 waits until the change signal is received. If the change signal has been received (S405: YES), the laser control unit 18 returns to step S401. The above-described process is repeatedly performed.

3.2.2 Calculation Process of Delay Time

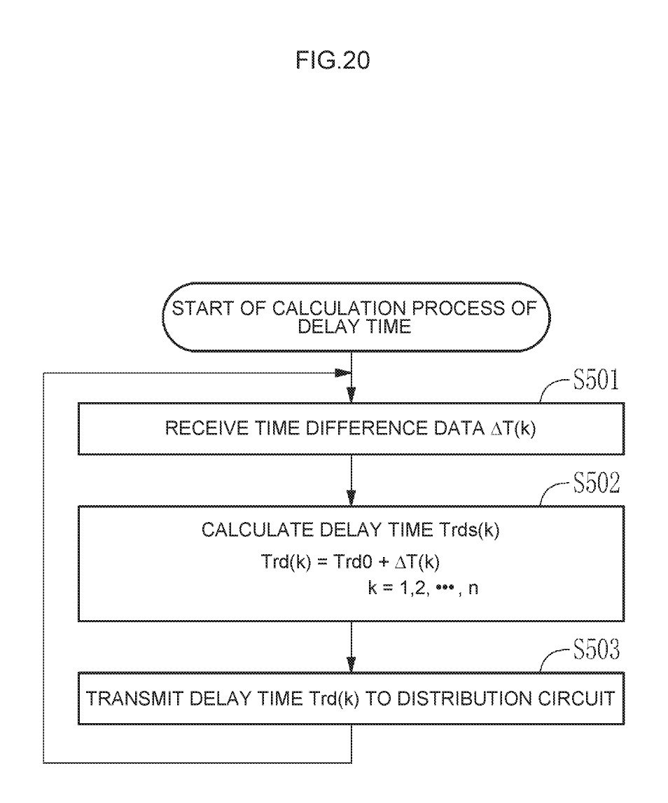

FIG. 20 illustrates a calculation process of the delay time Trd(k) performed by the delay time calculation unit 61. First, in step S501, the delay time calculation unit 61 receives the time difference data ΔT(k) transmitted from the laser control unit 18.

Next, in step S502, the delay time calculation unit 61 calculates the delay time Trd(k) based on the following formula (9).

Trd(k)=Trd0+ΔT(k) (9)

Here, Trd0 is a reference delay time, and is a constant value.

Next, in step S503, the delay time calculation unit 61 transmits the calculated delay time Trd(k) to the internal trigger signal generation unit 62, and returns to step S501. The above-described process is repeatedly performed.

3.2.3 Generation Process of Internal Trigger Signal

The internal trigger signal generation unit 62 receives and holds the delay time Trd(k) transmitted from the delay time calculation unit 61, and upon reception of the external trigger signal TR from the laser control unit 18, the internal trigger signal generation unit 62 generates the internal trigger signal TR(k) obtained by delaying the external trigger signal TR based on the formula (10).

TR(k)=TR+Trd(k) (10)

The internal trigger signal generation unit 62 inputs the generated internal trigger signal TR(k) to the TCS(k). There is the time difference ΔTch between TR(k−1) and T(k).

3.2.4 Overall Operation of Gas Laser Device

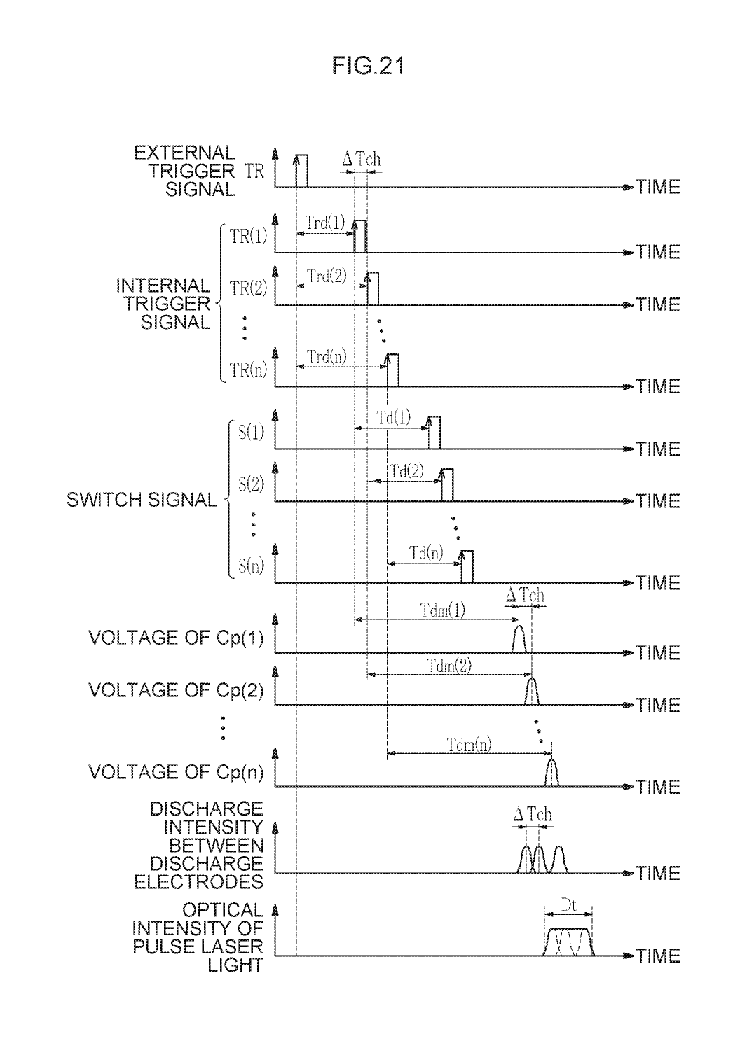

FIG. 21 is a timing chart in the gas laser device 2b according to the second embodiment. The overall operation of the gas laser device 2b will be described with reference to FIG. 21.

Upon reception of the data on the target pulse energy Et from the external device control unit 3, the laser control unit 18 calculates the setting value of the charged voltage V so that the pulse energy E of the pulse laser light PL approaches the target pulse energy Et, and transmits the calculated setting value of the charged voltage V to the charger 11 through the synchronization control unit 60.

In the synchronization control unit 60, the processing unit 52 in each TCS(k) calculates the delay time Td(k) based on the setting value of the charged voltage V and the reference delay time Td0(k), and transmits the data on the delay time Td(k) to the delay circuit 53.

Upon reception of the data on the target pulse width Dt from the external device control unit 3, the laser control unit 18 calculates the time difference data ΔT(k), and transmits the calculated time difference data to the delay time calculation unit 61 in the synchronization control unit 60. The delay time calculation unit 61 calculates the delay time Trd(k) based on the above-described formula (9), and inputs the calculated delay time to the internal trigger signal generation unit 62.

Upon reception of the external trigger signal TR from the laser control unit 18, the internal trigger signal generation unit 62 generates the internal trigger signal TR(k) based on the above-described formula (10) to input to the delay circuit 53 and the timer 54 in the TCS(k). As illustrated in FIG. 21, there is the time difference among the internal trigger signals TR(1) to TR(n).

Upon reception of the internal trigger signal TR(k), the timer 54 in each TCS(k) is reset and starts clocking. The internal trigger signal TR(k) input to each delay circuit 53 is delayed by the delay time Td(k), and is input to the switch 12a in the PPM(k) as a switch signal S(k).

As illustrated in FIG. 21, the switch signals S(1) to S(n) are input to the respective switches 12a in the PPM(1) to PPM(n) with time differences thereamong. The respective switches 12a in the PPM(1) to PPM(n) are turned ON sequentially for each time difference ΔTch. The pulse-compressed current pulse is output from the PPM(k) to the Cp(k) as an output pulse. As a result, the Cp(1) to Cp(n) are charged sequentially for each time difference ΔTch.

The output pulse from each PPM(k) is detected by the output pulse sensor A(k), and the detection signal D1(k) is transmitted to the timer 54 in the TCS(k). Upon reception of the detection signal D1(k), the timer 54 stops clocking, and inputs the measured time Tdm(k) from the input of the internal trigger signal TR(k) to the input of the detection signal D1(k) to the processing unit 52. Upon reception of the measured time Tdm(k), the processing unit 52 calculates the difference ΔTd(k) between the average value of the measured time Tdm(k) and the target value Tdt, and corrects the reference delay time Td0(k).

The Cp(k) is charged by the current pulse, resulting in the high voltage being applied to the first discharge electrode 20aₖ, and the pulse discharge being generated in the discharge space between the first discharge electrode 20aₖ and the second discharge electrode 20bₖ. As illustrated in FIG. 21, the pulse discharge is generated sequentially for each time difference ΔTch. Each pulse discharge results in laser oscillation, and the pulse laser light PL is emitted from the output coupling mirror 15. The pulse laser light PL is light on which the laser light output for each time difference ΔTch is superimposed, and therefore the pulse width becomes almost target pulse width Dt.

The pulse energy E of the pulse laser light PL output from the output coupling mirror 15 is measured by the pulse energy measurement unit 16. The laser control unit 18 reads the pulse energy E of the pulse laser light measured by the pulse energy measurement unit 16, and calculates the setting value of the charged voltage V so that the pulse energy E of the pulse laser light PL approaches the target pulse energy Et The above-described steps are repeated.

3.3 Effect

In the second embodiment, similarly to the first embodiment, the measured time Tdm(k) from the input of the internal trigger signal TR(k) to each TCS(k) to the output of the output pulse from the PPM(k) is controlled to approach the target value Tdt. Thus, the timings of the internal trigger signals TR(1) to TR(n) are controlled, thereby enabling the charging timings of the Cp(1) to Cp(n) to be controlled with high accuracy. Accordingly, in the second embodiment, the pulse width of the pulse laser light PL can be controlled with high accuracy to approach the target pulse width Dt.

In the second embodiment, when Dt is set to D0, and ΔTch is set to zero, the timings of charging the Cp(1) to Cp(n) can coincide with one another as with the first embodiment.

In the second embodiment, the pulse energy measurement unit 16 may include a PIN photodiode, or an ultraviolet photoelectric tube such as a biplanar tube, instead of the optical sensor 16c. In this case, the pulse energy measurement unit 16 can measure the pulse waveform in addition to the pulse energy of the pulse laser light PL. The laser control unit 18 may determine the pulse width based on the pulse waveform measured by the pulse energy measurement unit 16, and correct the time difference ΔTch so that this pulse width approaches the target pulse width Dt.

### 4. Third Embodiment

A gas laser device according to a third embodiment of the present disclosure will be described below. The gas laser device according to the third embodiment enables a pulse waveform of the pulse laser light to be controlled with high accuracy by making the timing of the switch signal and the charged voltage different for each PPM. Hereinafter, the constituent elements that are the same as the constituent elements of the gas laser device 2b according to the second embodiment are denoted by the same reference signs, and the description thereof is appropriately omitted.

4.1 Configuration

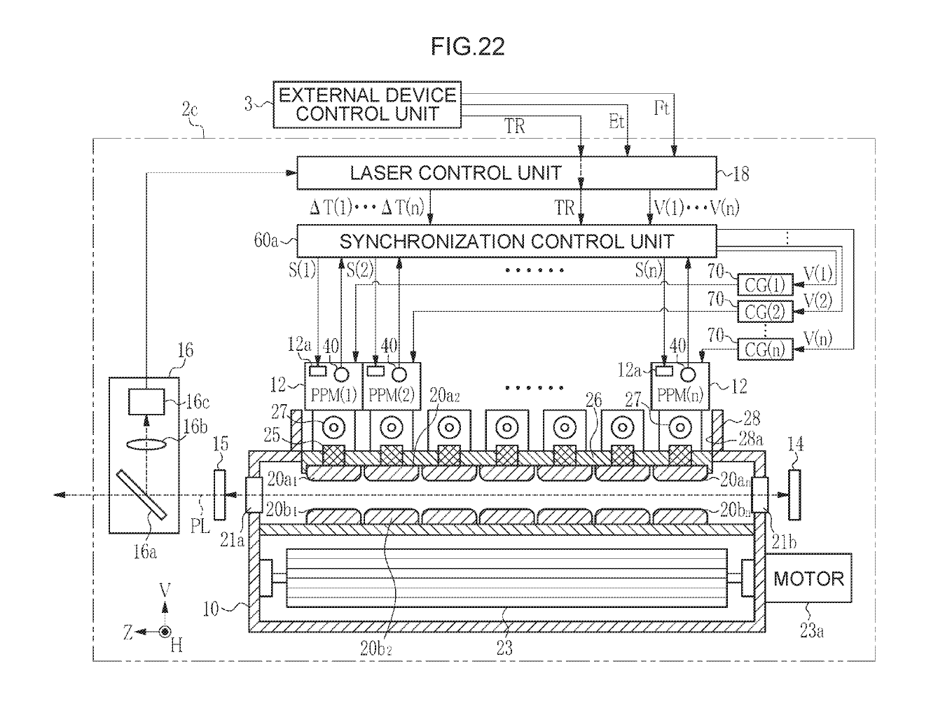

FIG. 22 schematically illustrates a configuration of a gas laser device 2c according to the third embodiment. In the third embodiment, the external device control unit 3 transmits, to the laser control unit 18, the data on the target pulse waveform Ft in addition to the external trigger signal TR and the data on the target pulse energy Et.

The third embodiment is different from the second embodiment in that the gas laser device 2c includes a plurality of chargers 70. The charger 70 is provided for each PPM(k). In other words, the total number of chargers 70 is n. Hereinafter, the charger 70 corresponding to the PPM(k) is referred to as a CG(k).

In the third embodiment, the laser control unit 18 calculates the time difference data ΔT(1) to ΔT(n) described later and the data on the charged voltages V(1) to V(n) based on the data on the target pulse waveform Ft input from the external device control unit 3, and transmits the calculated time difference data and the data on the charged voltages to a synchronization control unit 60a.

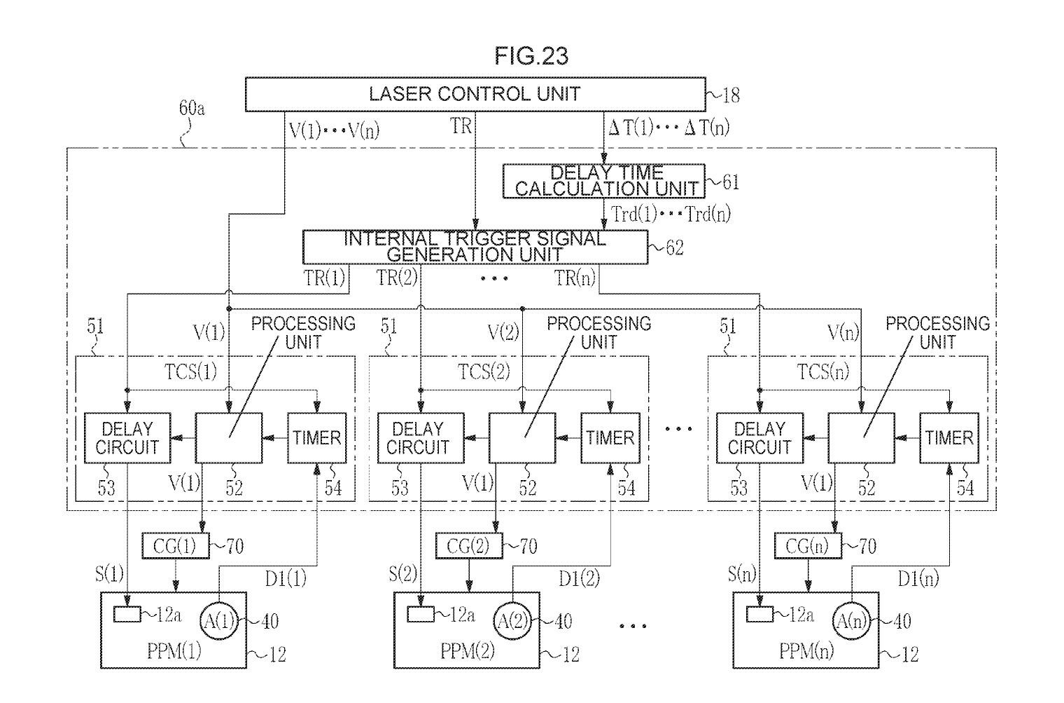

FIG. 23 illustrates a configuration of the synchronization control unit 60a according to the third embodiment. The synchronization control unit 60a has the same configuration as the synchronization control unit 60 according to the second embodiment except that the data on the charged voltage V(k) received from the laser control unit 18 is input to the processing unit 52 in the corresponding TCS(k).

The delay time calculation unit 61 calculates delay times Trd(1) to Trd(n) based on the time difference data. ΔT(1) to ΔT(n) input from the laser control unit 18, and inputs the calculated delay times to the internal trigger signal generation unit 62.

The processing unit 52 in the TCS(k) calculates the delay time Td(k) based on the data on the charged voltage V(k) to input to the delay circuit 53. The data on the charged voltage V(k) is input to the CG(k) through the processing unit 52 in the TCS(k).

The other configurations of the gas laser device 2c according to the third embodiment are the same as those of the gas laser device 2b according to the second embodiment.

4.2 Operation

4.2.1 Calculation Process of Time Difference Data and Charged Voltage

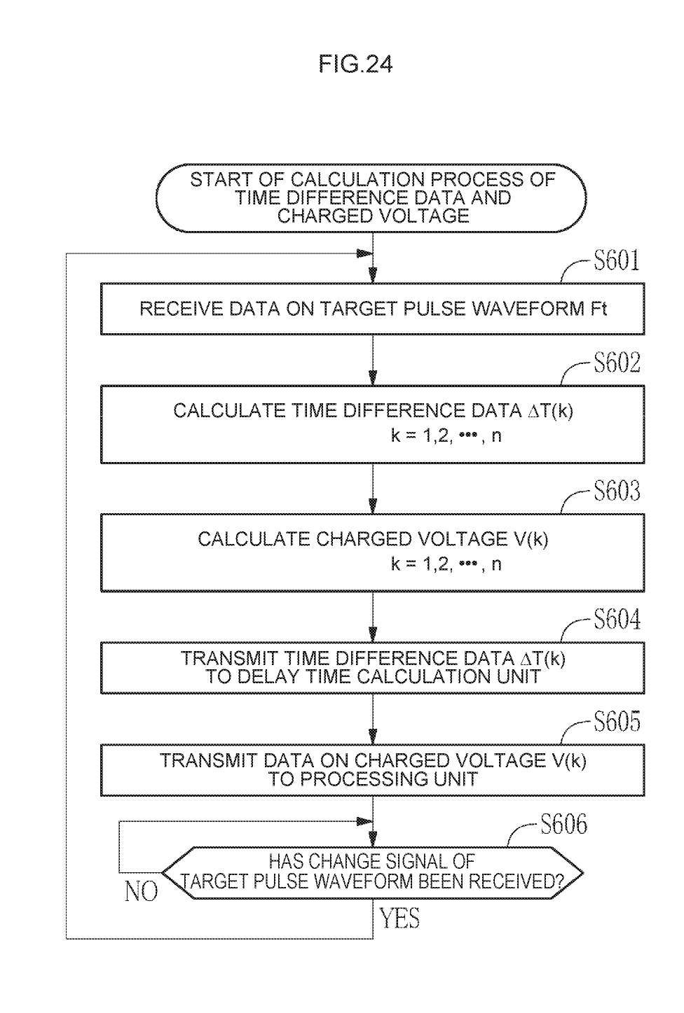

FIG. 24 illustrates a calculation process of time difference data ΔT(k) and a charged voltage V(k) which is performed by the laser control unit 18 of the third embodiment.

First, in step S601, the laser control unit 18 receives the data on the target pulse waveform Ft from the external device control unit 3. Next, in step S602, the laser control unit 18 calculates the time difference data ΔT(k) corresponding to the width of the target pulse waveform Ft based on the data on the target pulse waveform Ft. Next, in step S603, the laser control unit 18 calculates the charged voltage V(k) corresponding to an intensity distribution of the target pulse waveform Ft.

Next, in step S604, the laser control unit 18 transmits the calculated time difference data ΔT(k) to the delay time calculation unit 61 in the synchronization control unit 60a. Next, in step S605, the laser control unit 18 transmits the data on the calculated charged voltage V(k) to the processing unit 52 in the TCS(k).

Next, in step S606, the laser control unit 18 determines whether a change signal of the target pulse waveform Ft has been received from the external device control unit 3. If the change signal has not been received (S606: NO), the laser control unit 18 waits until the change signal is received. If the change signal has been received (S606: YES), the laser control unit 18 returns to step S601. The above-described process is repeatedly performed.

In the third embodiment, the laser control unit 18 controls an attenuator not illustrated without changing the setting value of the charged voltage V(k), so that the pulse energy F measured by the pulse energy measurement unit 16 approaches the target pulse energy Et. In other words, in the third embodiment, the attenuator not illustrated is controlled instead of S106 and S107 in the flowchart illustrated in FIG. 7.

4.2.2 Processing in Trigger Correction Unit

In the third embodiment, each TCS(k) performs the similar process to the process illustrated in the flowchart of FIG. 15. In the third embodiment, a different charged voltage V(k) for each TCS(k) is input, and therefore the following formula (2′) is used instead of the formula (2).

ΔTV(k)=F(V₀)−F[V(k)] (2′)

4.2.3 Overall Operation of Gas Laser Device

The overall operation of the gas laser device 2c according to the third embodiment will be described. First, upon reception of the data on the target pulse waveform Ft from the external device control unit 3, the laser control unit 18 calculates the time difference data ΔT(k) and the selling value of the charged voltage V(k), so that the pulse waveform of the pulse laser light PL approaches the target pulse waveform Ft, and transmits the calculated time difference data and setting value of the charged voltage V(k) to the synchronization control unit 60a.

In the synchronization control unit 60a, the processing unit 52 in each TCS(k) calculates the delay time Td(k) based on the charged voltage V(k) and the reference delay time Td0(k), and transmits the data on the delay time Td(k) to the delay circuit 53. In the synchronization control unit 60a, the delay time calculation unit 61 calculates the delay time Trd(k) for each TCS(k) based on the above-described formula (9), and inputs the calculated delay time to the internal trigger signal generation unit 62.

Upon reception of the external trigger signal TR from the laser control unit 18, the internal trigger signal generation unit 62 generates the internal trigger signal TR(k) based on the above-described formula (10) to input to the delay circuit 53 and the timer 54 in the TCS(k). Upon reception of the internal trigger signal TR(k), the timer 54 in each TCS(k) is reset and starts clocking. The internal trigger signal TR(k) input to each delay circuit 53 is delayed by the delay time Td(k), and is input to the switch 12a in the PPM(k) as a switch signal S(k).

The switch signals S(1) to S(n) are input to the respective switches 12a in the PPM(1) to PPM(n) with time differences thereamong. The respective switches 12a in the PPM(1) to PPM(n) are turned ON sequentially. The pulse-compressed current pulse is output from each PPM(k) to the Cp(k) as an output pulse. As a result, the Cp(1) to Cp(n) are charged sequentially.

The output pulse from each PPM(k) is detected by the output pulse sensor A(k), and the detection signal D1(k) is transmitted to the timer 54 in the TCS(k). Upon reception of the detection signal D1(k), the timer 54 stops clocking, and inputs the measured time Tdm(k) from the input of the internal trigger signal TR(k) to the input of the detection signal D1(k) to the processing unit 52. Upon reception of the measured time Tdm(k), the processing unit 52 calculates the difference ΔTd(k) between the average value of the measured time Tdm(k) and the target value Tdt, and corrects the reference delay time Td0(k).

The Cp(k) is charged by the current pulse, resulting in the high voltage being applied to the first discharge electrode 20aₖ, and the pulse discharge being generated in the discharge space between the first discharge electrode 20aₖ and the second discharge electrode 20bₖ. The voltage applied to the first discharge electrode 20aₖ varies depending on the charged voltage V(k).

Each pulse discharge results in laser oscillation, and the pulse laser light PL is emitted from the output coupling mirror 15. The pulse laser light PL is light on which a plurality of laser lights generated by the discharge timing corresponding to the time difference data ΔT(k) and the excitation intensity corresponding to the charged voltage V(k) are superimposed, and therefore the pulse waveform becomes almost target pulse waveform Ft.

The pulse energy E of the pulse laser light PL output from the output coupling mirror 15 is measured by the pulse energy measurement unit 16. The laser control unit 18 reads the pulse energy E of the pulse laser light measured by the pulse energy measurement unit 16, and controls an attenuator not illustrated so that the pulse energy E of the pulse laser light approaches the target pulse energy Et. The above-described steps are repeated.

4.3 Effect

In the third embodiment, the timings of the internal trigger signals TRW to TR(n) and the charged voltages V(1) to V(n) are controlled, thereby enabling the charging timings of the Cp(1) to Cp(n) and the excitation intensity to be controlled with high accuracy. Accordingly, in the third embodiment, the pulse waveform of the pulse laser light PL can be controlled with high accuracy to approach the target pulse waveform Ft.

In the third embodiment, the pulse energy measurement unit 16 may include a PIN photodiode, or an ultraviolet photoelectric tube such as a biplanar tube, instead of the optical sensor 16c. In this case, the pulse energy measurement unit 16 can measure the pulse waveform in addition to the pulse energy of the pulse laser light PL. The laser control unit 18 may determine the difference between the pulse waveform measured by the pulse energy measurement unit 16 and the target pulse waveform Ft, and correct the time difference data ΔT(k) and the charged voltage V(k) so that the difference becomes smaller.

### 5. Fourth Embodiment

In the first embodiment, the timing of charging the peaking capacitor is detected, but the time period from when the peaking capacitor is charged to when the discharge is practically generated in the discharge space may vary. This is caused by the variation in gas pressure of the laser gas, for example. The gas laser device according to the fourth embodiment enables variation in time period from the input of the external trigger signal to the practical generation of discharge to be suppressed. Hereinafter, the constituent elements that are the same as the constituent elements of the gas laser device 2a according to the first embodiment are denoted by the same reference signs, and the description thereof is appropriately omitted.

5.1 Configuration

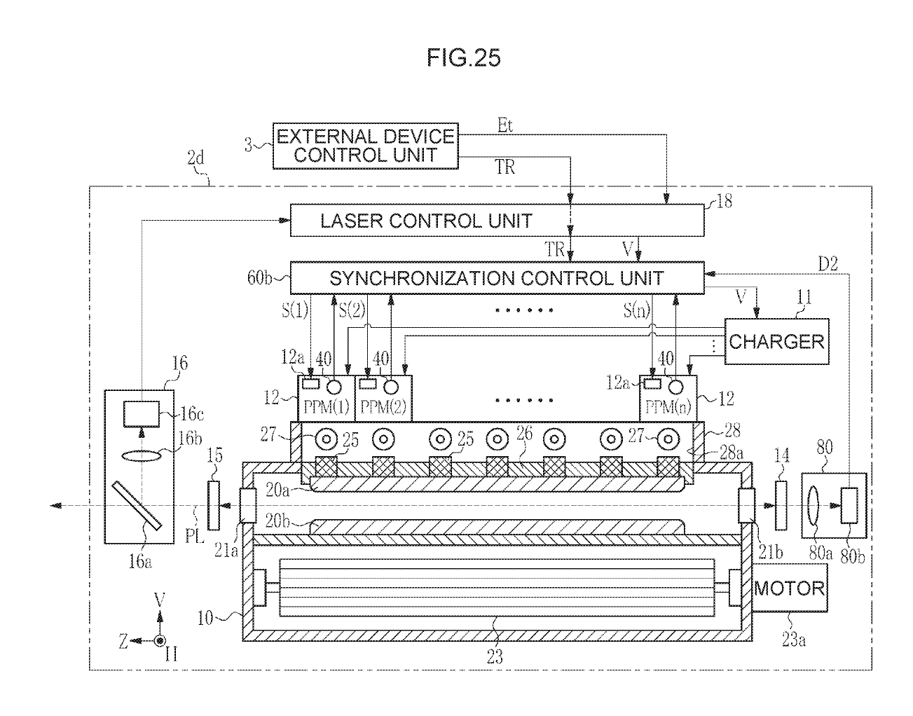

FIG. 25 schematically illustrates a configuration of a gas laser device 2d according to the fourth embodiment. In the fourth embodiment, a discharge sensor 80 is provided on the side opposite to the laser chamber 10 with respect to the rear mirror 14. The discharge sensor 80 includes a focusing optical system 80a, and an optical sensor 80b. The optical sensor 80b is a sensor sensitive to visible light, and includes a photodiode, or a photoelectric tube.

The rear mirror 14 is configured of a substrate coated with a multilayer film which allows the visible light to pass therethrough at high transmittance and allows the pulse laser light to be reflected at high reflectivity. The discharge light generated in the discharge space includes ultraviolet laser light and visible light. The focusing optical system 80a focuses the visible light which is emitted from the inside of the laser chamber 10 through the window 21b and is transmitted through the rear mirror 14 on the light collecting face of the optical sensor 80b. Upon detection of the visible light, the optical sensor 80b transmits the detection signal D2 to the synchronization control unit 60b.

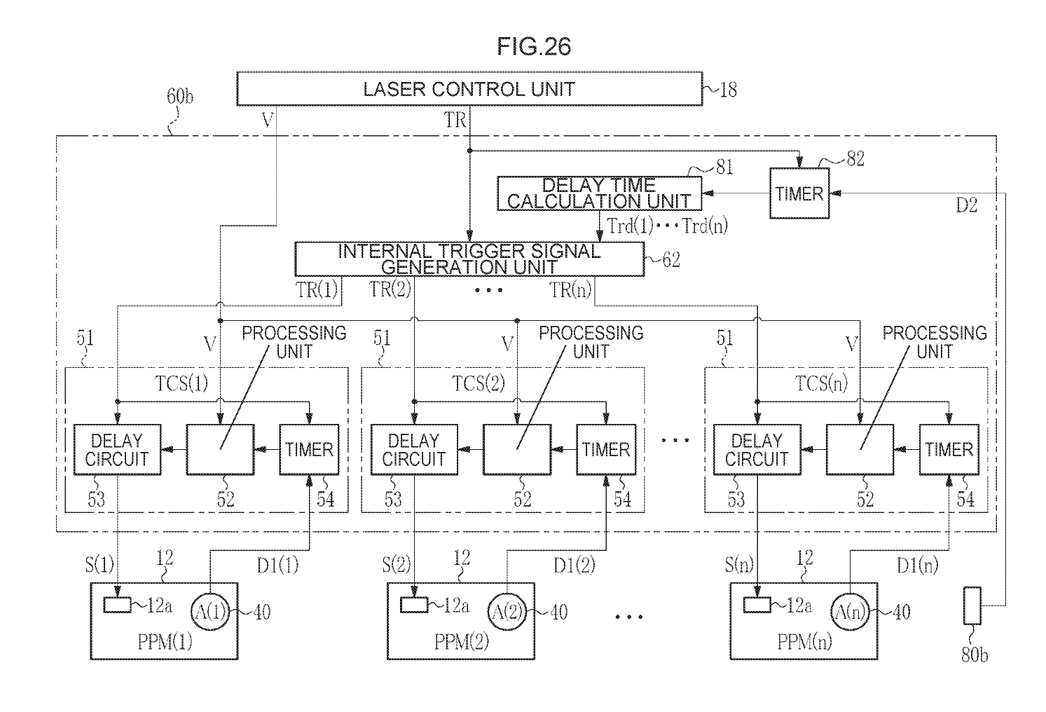

FIG. 26 illustrates a configuration of the synchronization control unit 60b according to the fourth embodiment. The synchronization control unit 60b includes a delay time correction unit 81 and a timer 82, in addition to the configuration of the synchronization control unit 60 according to the first embodiment. The external trigger signal TR is input to the timer 82 from the laser control unit 18. The detection signal D2 is input to the timer 82 from the optical sensor 80b.

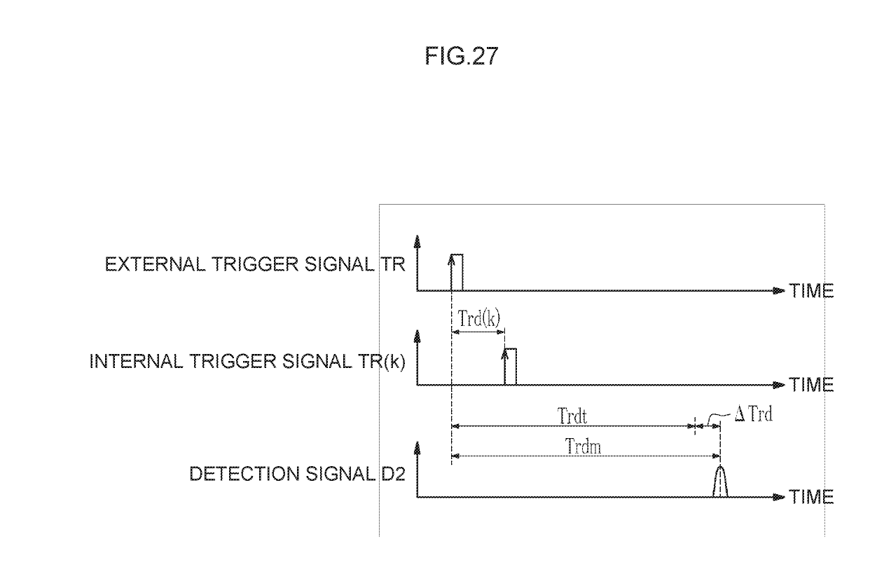

The timer 82 starts clocking upon input of the external trigger signal TR and stops clocking upon input of the detection signal D1 In other words, as illustrated in FIG. 27, the tinier 82 measures the time Trdm required from the time of inputting the external trigger signal TR to the time of inputting the detection signal D2. The timer 82 inputs the data on the measured time Trdm to the delay time correction unit 81.

The delay time correction unit 81 calculates the delay time Trd(k) based on the data on the measured time Trdm input from the timer 82. The delay time Trd(k) represents a time period from when the internal trigger signal generation unit 62 receives the external trigger signal TR to when the internal trigger signal generation unit 62 outputs the internal trigger signal TR(k), in other words, the delay time of the internal trigger signal TR(k) to the external trigger signal TR.

The other configurations of the gas laser device 2d according to the fourth embodiment are the same as those of the gas laser device 2a according to the first embodiment.

5.2 Operation

5.2.1 Correction Process of Delay Time of Internal Trigger Signal to External Signal

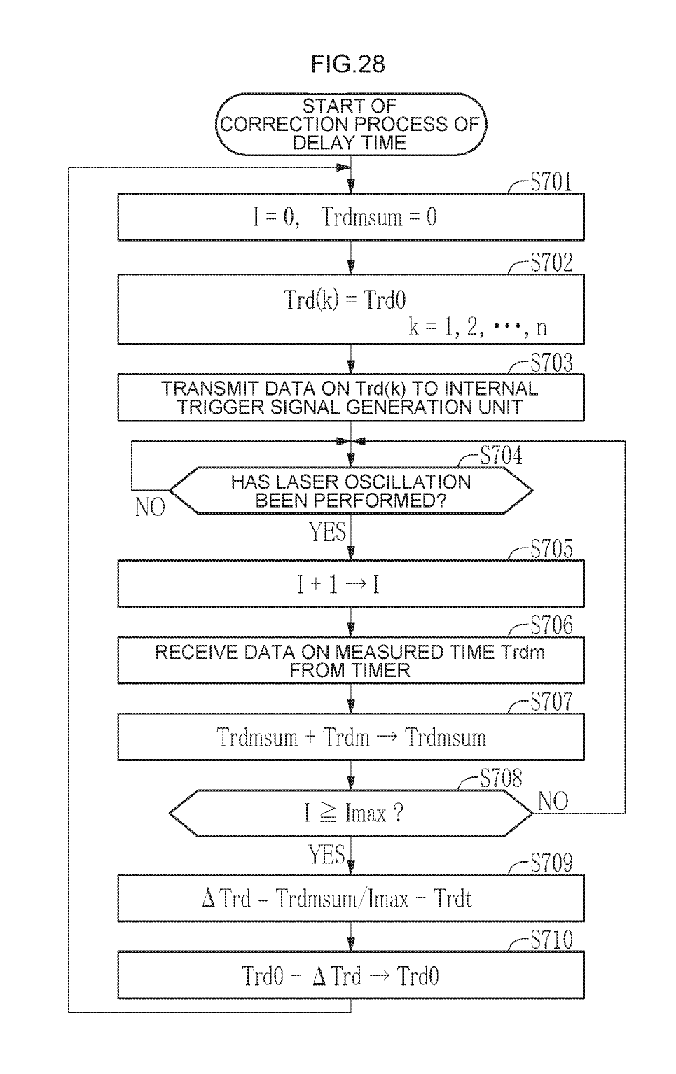

FIG. 28 is a flowchart illustrating a correction process of a delay time Trd(k) by the delay time correction unit 81. The delay time correction unit 81 corrects the delay time Trd(k) by the following process.

First, in step S701, the delay time correction unit 1 resets variables as follows.

I=0

Trdmsum=0

Here, I is a counter for counting the number of oscillation pulses. Trdmsum is a total value for calculating the average value of the measured time Trdm measured by the timer 82.

Next, in step S702, the delay time correction unit 81 sets all of delay times Trd(1) to Trd(n) to a reference delay time Trd0. Next, in step S703, the delay time correction unit 81 transmits the data on the delay time Trd(k) to the internal trigger signal generation unit 62.

Next, in step S704, the delay time correction unit 81 determines whether the gas laser device 2d has performed laser oscillation. Whether the gas laser device 2d has performed laser oscillation is determined based on whether the timer 82 has received the detection signal D2 from the optical sensor 80b. If the gas laser device 2d has performed laser oscillation (S704: YES), the delay time correction unit 81 proceeds to step S705. If the gas laser device 2d has not performed laser oscillation (S704: NO), the delay time correction unit 81 waits until the gas laser device 2d performs laser oscillation.

In step S705, the delay time correction unit 81 adds 1 to the present value of the counter I to update the value of I. Next, in step S706, the delay time correction unit 81 receives the data on the measured time Trdm from the timer 82. Next, in step S707, the delay time correction unit 81 adds the measured time Trdm to the present total value Trdmsum to update the total value Trdmsum.

Next, in step S708, the delay time correction unit 81 determines whether the value of the counter I has reached a predetermined value Imax representing the number of samples. If the value of the counter I has not reached the predetermined value Imax (S708: NO), the delay time correction unit 81 returns to step S704. If the value of the counter I has reached the predetermined value Imax (S708: YES), the delay time correction unit 81 proceeds to step S709.

In step S709, the delay time correction unit 81 calculates the difference ΔTrd between the average value of the measured time Trdm and the target value Trdt. The difference ΔTrd is calculated by the following formula (11).

ΔTrd=Trdmsum(k)/Imax−Trdt (11)

Next, in step S710, the delay time correction unit 81 calculates a new reference delay time Trd0 which is a value obtained by subtracting the difference ΔTrd from the reference delay time Trd0. Thus, after correcting the reference delay time Trd0, the delay time correction unit 81 returns to step S701. The above-described process is repeated.

Upon reception of the external trigger signal TR from the laser control unit 18, the internal trigger signal generation unit 62 generates the internal trigger signal TR(k) obtained by delaying the external trigger signal TR by the delay Trd(k), and inputs the generated internal trigger signal to the TCS(k).

As described above, in steps S704 to S709, a third correction process (drift correction process) for correcting the timing of the switch signal S(k) is performed based on the detection result of the optical sensor 80b.

It is preferable that the number of samples Imax is larger than the above-described number of samples Jmax, and particularly, is 2,000 or more and 100,000 or less. In other words, it is preferable that the frequency of the third correction process is lower than the frequency of the second correction process.

5.2.2 Overall Operation of Gas Laser Device

Hereinafter, the overall operation of the gas laser device 2d according to the fourth embodiment will be described. Upon reception of the external trigger signal TR from the external device control unit 3, the laser control unit 18 inputs the external trigger signal TR to the timer 82 and the internal trigger signal generation unit 62. Upon reception of the external trigger signal TR, the timer 82 is reset and starts clocking.

Upon reception of the external trigger signal TR, the internal trigger signal generation unit 62 generates the internal trigger signal TR(k) obtained by delaying the external trigger signal TR by the delay Trd(k) input from the delay time correction unit 81, and inputs the generated internal trigger signal to the TCS(k). After this, the operation similar to the first embodiment is performed, and pulse discharge is generated in the discharge space in the laser chamber 10. At this time, the ultraviolet laser light is emitted, and the visible light is emitted. A part of this visible light is transmitted through the rear mirror 14, and is detected by the optical sensor 80b.

Upon detection of the visible light, the optical sensor 80b transmits the detection signal D2 to the timer 82. Upon reception of the detection signal D2, the timer 82 stops clocking, and inputs the measured time Trdm from the input of the external trigger signal TR to the input of the detection signal D2 to the delay time correction unit 81. Upon reception of the measured time Trdm, the delay time correction unit 81 performs the above-described process, calculates the difference ΔTrd between the average value of the measured time Trdm and the target value Trdt, and corrects the reference delay time Trd0.

The other operations of the gas laser device 2d according to the fourth embodiment are the same as those of the gas laser device 2a according to the first embodiment.

5.3 Effect

In the fourth embodiment, the reference delay time Trd0 of the internal trigger signal TR(k) to the external trigger signal TR is corrected based on the difference ΔTrd between the average value of the measured time Trdm and the target value Trdt. The difference ΔTrd calculated in the next cycle is corrected by the difference ΔTrd. Thus, the timing of the switch signal S(k) is corrected, so that the measured time Trdm approaches the target value Trdt.

Thus, the synchronization control unit 60b performs the third correction process for correcting the timing of the switch signal S(k) based on the detection result of the discharge timing by the optical sensor 80b. As a result, variation in time period from the input of the external trigger signal TR to the gas laser device 2d to the practical generation of discharge can be suppressed.

When the optical resonator of the free-run oscillation including the rear mirror 14 and the output coupling mirror 15 is used as with the fourth embodiment, the loss is small. Therefore, the timing of discharge approximately coincides with the timing of the pulse laser light PL output from the output coupling mirror 15. Thus, in the fourth embodiment, accuracy in synchronization between the external trigger signal TR and the pulse laser light PL is improved, thereby improving the accuracy of the partial processing when the gas laser device 2d is applied to the processing laser device, and the accuracy of the laser irradiation when the gas laser device 2d is applied to the laser annealing device.

In the fourth embodiment, the discharge sensor 80, the delay time correction unit 81, and the timer 82 are added to the gas laser device 2a according to the first embodiment. These may be added to the gas laser device 2b according to the second embodiment or the gas laser device 2c according to the third embodiment, so that the reference delay time Trd0 is corrected as with the fourth embodiment.

In the fourth embodiment, the discharge timing is detected by the discharge sensor 80 which is disposed on a back surface side of the rear mirror 14, and the discharge timing may be detected by the optical sensor 16c included in the pulse energy measurement unit 16.

### 6. Specific Example of Output Pulse Sensor

Hereafter, a specific example of the output pulse sensor 40 for detecting the charging timing of the peaking capacitor 27 will be described. The output pulse sensor 40 includes two types being a current detection system and a voltage detection system.

6.1 Output Pulse Sensor in Current Detection System

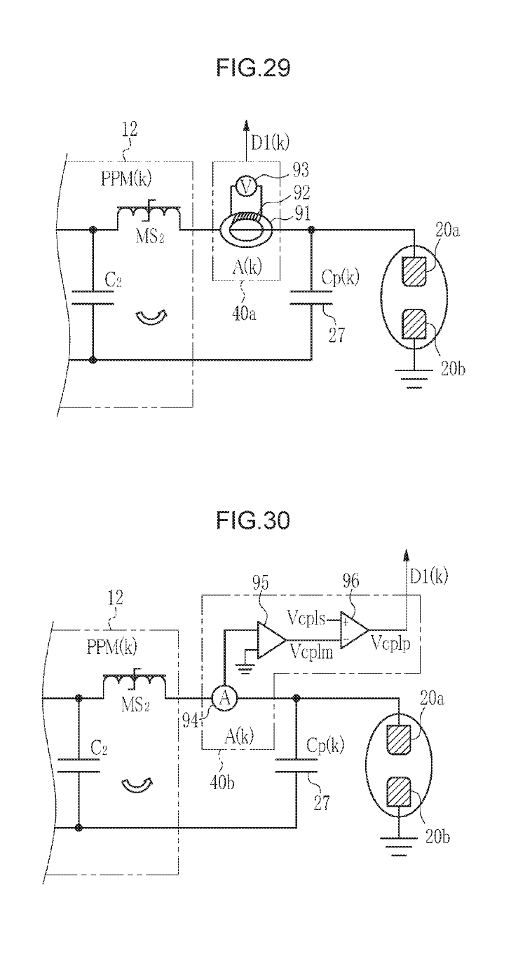

FIG. 29 illustrates a specific example of an output pulse sensor in the current detection system. In FIG. 29, the output pulse sensor 40a is a current sensor including a magnetic core 91, a coil 92, and a voltmeter 93. A wire connecting the magnetic switch MS₂ and the peaking capacitor 27 is inserted into a hollow portion of the magnetic core 91. The coil 92 is wound around a part of the magnetic core 91, and both ends of the coil 92 are connected to the voltmeter 93. The voltmeter 93 detects an induced voltage which is generated in the magnetic core 91 when the current pulse flows in the above-described wire. The detected voltage of the induced voltage is transmitted to the tinier 54 as the above-described detection signal D1(k).

The output pulse sensor may be a current sensor including Rogosky coils. The output pulse sensor may be a hall element current sensor in which a hall element is arranged in a gap part in the magnetic core.

FIG. 30 illustrates a specific example of an output pulse sensor for detecting a charging timing based on a waveform of a current flowing through the peaking capacitor 27. In FIG. 30, the output pulse sensor 40b includes a current sensor 94, an amplifier 95, and a comparator 96. The current sensor 94 is disposed between the magnetic switch MS₂ and the peaking capacitor 27, and detects a current flowing through the peaking capacitor 27 to output the current to the amplifier 95. The amplifier 95 converts the current input from the current sensor 94 into the voltage Vcplm to output the voltage to the comparator 96.

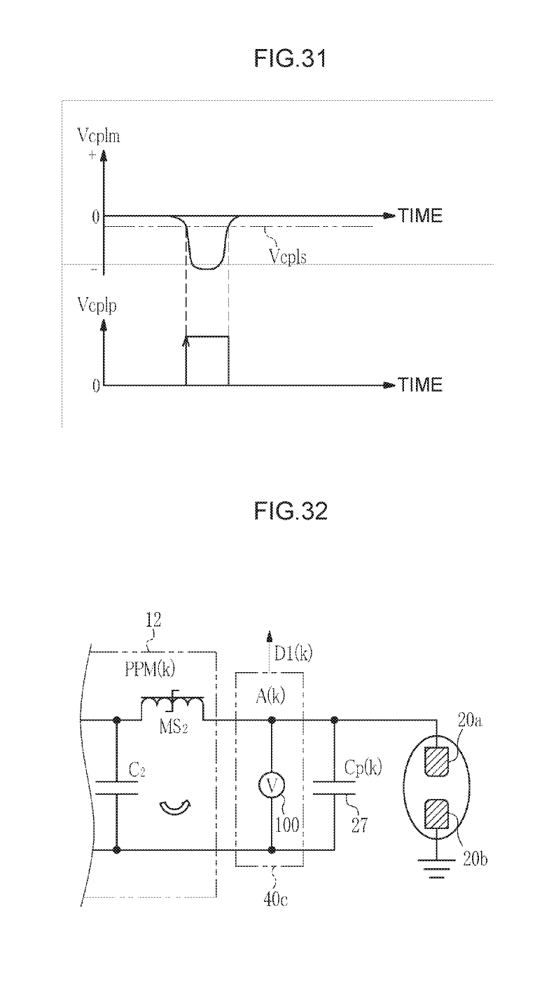

As shown in FIG. 31, the comparator 96 compares the voltage Vcplm input from the amplifier 95 with the reference voltage Vcpls, and outputs a constant voltage Vcplp when the voltage Vcplm is lower than the reference voltage Vcpls. This voltage Vcplp is in a pulse form, and is transmitted to the timer 54 as the above-described detection signal D1(k).

The reference voltage Vcpls is set to a negative value close to zero to detect the rising and falling timings of the voltage Vcplm. It is preferable that the timer 54 detects the rising timing of the voltage Vcplp. In this case, the charging start timing of the peaking capacitor 27 can be detected.

The timer 54 may detect the falling timing of the voltage Vcplp. In this case, the charging completion timing of the peaking capacitor 27 can be detected. Since the charging completion timing is close to the discharge timing in the discharge space, the detection of the charging completion timing enables the discharge timing to be detected with high accuracy.

6.2 Output Pulse Sensor in Voltage Detection System

FIG. 32 illustrate a specific example of an output pulse sensor in the voltage detection system. In FIG. 32, the output pulse sensor 40c includes a voltmeter 100 which is connected in parallel with the peaking capacitor 27. The voltmeter 100 detects the voltage applied to the peaking capacitor 27 from the PPM 12. This detection voltage is transmitted to the timer 54 as the above-described detection signal D1(k).

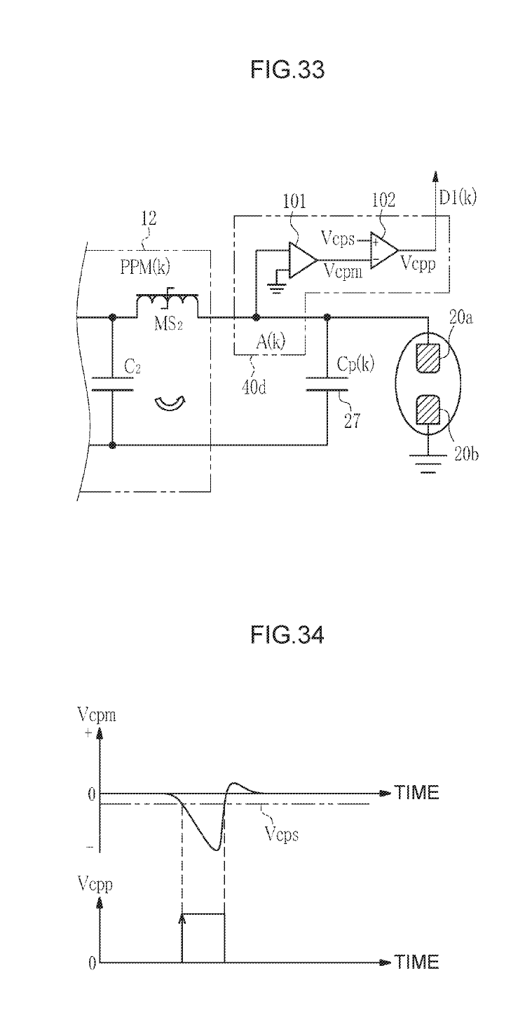

FIG. 33 illustrates a specific example of an output pulse sensor for detecting a charging timing based on a waveform of a voltage applied to the peaking capacitor 27. In FIG. 33, the output pulse sensor 40d includes an amplifier 101, and a comparator 102. The amplifier 101 is connected to the wire between the magnetic switch MS₂ and the peaking capacitor 27. The voltage applied to the peaking capacitor 27 is input to the amplifier 101. The amplifier 101 converts the voltage applied to the peaking capacitor 27 into the voltage Vcpm to output the converted voltage to the comparator 102.

As shown in FIG. 34, the comparator 102 compares the voltage Vcpm input from the amplifier 101 with the reference voltage Vcps, and outputs a constant voltage Vcpp when the voltage Vcpm is lower than the reference voltage Vcps. This voltage Vcpp is in a pulse form, and is transmitted to the timer 54 as the above-described detection signal D1(k).

The reference voltage Vcps is set to a negative value close to zero to detect the rising and falling timings of the voltage Vcpm. The tinter 54 detects the rising timing of the voltage Vcpp or the falling timing of the voltage Vcpp.

### 7. Specific Example of Discharge Sensor

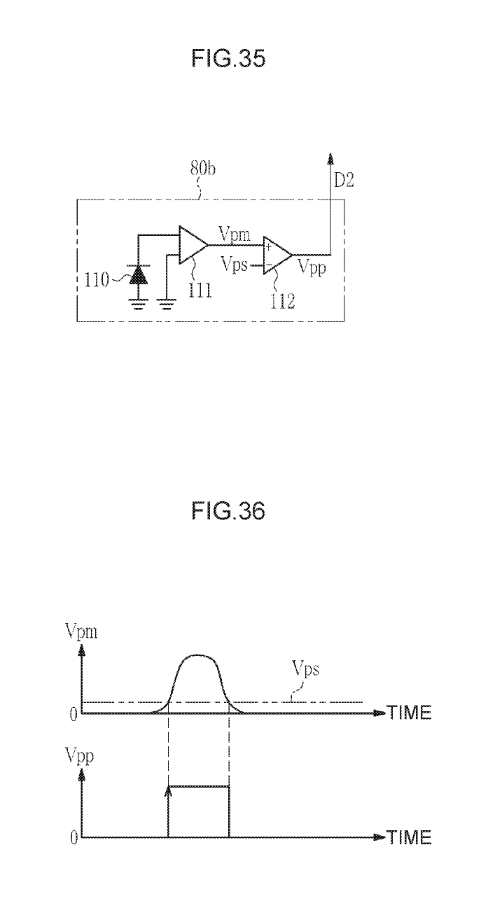

FIG. 35 illustrates a specific example of an optical sensor 80b included in a discharge sensor 80. The optical sensor 80b includes a photodiode 110, an amplifier 111, and a comparator 112. The photodiode 110 is sensitive to visible light, and outputs the current corresponding to the light intensity of the received visible light to the amplifier 111. The amplifier 111 converts the current input from the photodiode 110 into the voltage Vpm to output the converted voltage to the comparator 112.

As shown in FIG. 36, the comparator 112 compares the voltage Vpm input from the amplifier III with the reference voltage Vps, and outputs a constant voltage Vpp when the voltage Vpm is higher than the reference voltage Vps. This voltage Vpp is in a pulse form, and is transmitted to the timer 82 as the above-described detection signal D2.

The reference voltage Vps is set to a positive value close to zero to detect the rising and falling timings of the voltage Vrpm. It is preferable that the timer 82 detects the rising timing of the voltage Vpp. In this case, the discharge timing in the discharge space can be detected with high accuracy.

The above-described embodiments and specific examples may be combined unless any contradiction occurs. The descriptions provided above are intended to provide just examples without any limitations. Accordingly, it will be obvious to those skilled in the art that change can be made to the embodiments of the present disclosure without departing from the scope of the accompanying claims.

The terms used in the present specification and in the entire scope of the accompanying claims should be construed as terms “without limitations.” For example, a term “including” or “included” should be construed as “not limited to that described to be included.” A term “have” should be construed as “not limited to that described to be held.” Moreover, a modifier “a/an” described in the present specification and in the accompanying claims should be construed to mean “at least one” or “one or more.”

What is claimed is:

1. A discharge excitation gas laser device, comprising:
(A) first and second discharge electrodes disposed to face each other;
(B) a plurality of peaking capacitors connected to the first discharge electrode;
(C) a charger;
(D) a plurality of pulse power modules,
each one of the pulse power modules including the following (D1) to (D3):
(D1) a charging capacitor to which a charged voltage is applied from the charger;
(D2) a pulse compression circuit that pulse-compresses electrical energy stored in the charging capacitor, and outputs the pulse-compressed electrical energy as an output pulse to a corresponding peaking capacitor of the peaking capacitors; and
(D3) a switch disposed between the charging capacitor and the pulse compression circuit;
(E) a plurality of output pulse sensors, each one of the output pulse sensors detecting an output pulse output by a corresponding one of the pulse power modules; and
(F) a control unit configured to control, based on a detection result of each of the output pulse sensors, a timing of a switch signal to be input to a corresponding switch.

2. The gas laser device according to claim 1, wherein
the control unit performs a first correction process to correct a timing of the switch signal based on the charged voltage, and a second correction process to correct a timing of the switch signal based on a detection result of each of the output pulse sensors.

3. The gas laser device according to claim 1, wherein
the first discharge electrode is provided for each pulse power module.

4. The gas laser device according to claim 3, wherein
the control unit controls a pulse width of a pulse laser light generated in a discharge space between the first and second discharge electrodes by changing a timing of the switch signal to he input to each of the switches.

5. The gas laser device according to claim 4, wherein
the control unit determines the timing of the switch signal to be input to each of the switches based on a target pulse width input from an outside.

6. The gas laser device according to claim 1, wherein
only one charger is provided, and the charger supplies a constant charged voltage to the pulse power modules.

7. The gas laser device according to claim 1, wherein
the charger is provided for each pulse power module, and
each charger applies the charged voltage to the corresponding pulse power module.

8. The gas laser device according to claim 7, wherein
the control unit controls a pulse waveform of the pulse laser light emitted from the discharge space between the first and second discharge electrodes by changing a timing of the switch signal to be input to each of the switches and changing the charged voltage output by each charger.

9. The gas laser device according to claim 8, wherein
the control unit determines the timing of the switch signal to be input to each of the switches and the charged voltage output by each charger based on a target pulse waveform input from an outside.

10. The gas laser device according to claim 1, wherein
the output pulse sensor detects a current flowing through the peaking capacitor.

11. The gas laser device according to claim 10, wherein
the output pulse sensor detects a rising timing or a falling timing of the current flowing through the peaking capacitor.

12. The gas laser device according to claim 1, wherein
the output pulse sensor detects a voltage to be applied to the peaking capacitor.

13. The gas laser device according to claim 12, wherein
the output pulse sensor detects a rising timing or a falling timing of a voltage to be applied to the peaking capacitor.

14. The gas laser device according to claim 1, wherein
the pulse compression circuit includes at least one magnetic switch, and
the output pulse sensor is connected between the magnetic switch and the peaking capacitor.

15. The gas laser device according to claim 2, further comprising
(G) an optical sensor configured to detect a light generated in a discharge space between the first and second discharge electrodes, wherein
the control unit further performs a third correction process to correct the timing of the switch signal to be input to each of the switches based on a detection result of the optical sensor.

16. The gas laser device according to claim 15, wherein
a frequency of the third correction process is lower than a frequency of the second correction process, and
the frequency of the second correction process is lower than a frequency of the first correction process.

17. The gas laser device according to claim 15, wherein
the optical sensor detects a discharge timing by receiving a discharge light or a pulse laser light generated in the discharge space.

18. The gas laser device according to claim 1, wherein
the control unit generates the switch signal to be input to each of the switches based on an external trigger signal input from an outside.

19. The gas laser device according to claim 1, further comprising
(H) a pulse energy measurement unit configured to measure energy of the pulse laser light emitted from a discharge space between the first and second discharge electrodes, wherein
the control unit changes the charged voltage based on a difference between a target pulse energy input from an outside and pulse energy measured by the pulse energy measurement unit.
